(19) United States
(12) Patent Application Publication
(10) Pub. No.: US 2014/0118580 A1
(43) Pub. Date: May 1, 2014

(54) IMAGE PROCESSING DEVICE, IMAGE PROCESSING METHOD, AND PROGRAM

(71) Applicant: SONY CORPORATION, Minato-ku (JP)

(72) Inventors: Hiroaki Ono, Kanagawa (JP); Teppei Kurita, Tokyo (JP); Tomoo Mitsunaga, Kanagawa (JP)

(73) Assignee: SONY CORPORATION, Minato-ku (JP)

(21) Appl. No.: 14/030,307

(22) Filed: Sep. 18, 2013

(30) Foreign Application Priority Data
Oct. 31, 2012 (JP) 2012-240079

(51) Int. Cl. H04N 9/64; H04N 5/217

(52) U.S. Cl. CPC H04N 9/646; H04N 5/217
USPC 348/242

(57) ABSTRACT

Provided is an image processing device including an image processing unit that sets a RAW image in which a pixel value of a specific color is set in each pixel as an input image and reduces a noise component contained in the input image. The image processing unit includes a local region selection unit, a similar local region selection unit, a band separation unit, a band-classified noise reduction unit, a band combining unit, and a local region combining unit.

### CROSS REFERENCE TO RELATED APPLICATIONS

This application claims the benefit of Japanese Priority Patent Application JP 2012-240079 filed Oct. 31, 2012, the entire content of which is incorporated herein by reference.

### BACKGROUND

The present disclosure relates to an image processing device, an image processing method, and a program, and more particularly, to an image processing device, an image processing method, and a program performing a noise reduction process on a RAW image set as a processing target, which is an output of an image sensor of a camera, that is, a RAW image in which only a pixel value of a specific color is set in each pixel.

Image sensors used in imaging devices such as digital cameras include color filters with, for example, an RGB array and have a configuration in which light with a specific wavelength is incident on each pixel.

Specifically, color filters with, for example, a Bayer array are considerably used.

In a captured image with the Bayer array, only a pixel value corresponding to one color of RGB is set in each pixel of an image sensor, and thus a so-called mosaic image is formed. An image processing unit of a camera performs a demosaicing process of setting a whole pixel value of RGB in each pixel by performing various kinds of signal processing such as pixel value interpolation on the mosaic image, and then generates and outputs a color image.

In general, a noise component of a predetermined amount is included in the pixel value of a photographed image. Accordingly, many cameras have configurations in which a noise reduction process is performed on a photographed image to remove noise components included in pixel values and to generate an output image.

As a noise reduction process in an imaging device (camera), one of the following two processes can be considered.

One is a process that is performed on an RGB image after an image subjected to the above-described demosaicing process, that is, an RGB image in which a whole pixel value of RGB is set in each pixel, is generated.

The other is a process that is performed on a so-called mosaic image in which only a pixel value corresponding to one color of RGB is set in each pixel before the demosaicing process.

Japanese Unexamined Patent Application Publication No. 2004-127064 is a document that discloses a noise reduction process for an RGB image in which a whole pixel value of RGB is set in each pixel.

Japanese Unexamined Patent Application Publication No. 2004-127064 discloses a method of reducing noise by performing a wavelet transform and a coring process on each signal after separating an RGB image into a luminance signal and a color difference signal.

The wavelet transform is a process of separating various frequency components included in an image and separating the image into signals in predetermined units of frequency components. The coring process is, for example, a process of destroying or reducing data with a value less than a predetermined threshold value and outputting the data. The components reduced through the coring process are interpreted as being noise components.

Japanese Unexamined Patent Application Publication No. 2004-127064 discloses the method of performing the noise reduction process by performing the wavelet transform and the coring process in this way.

The method disclosed in Japanese Unexamined Patent Application Publication No. 2004-127064 is configured to be performed by generating a luminance image and a color difference image from the image subjected to the demosaicing process, that is, the RGB image in which the pixel value of all of the RGB colors are set in each pixel, and applying each of the images.

Japanese Unexamined Patent Application Publication No. 2004-127064 does not disclose a noise reduction process performed using an image not subjected to the demosaicing process, that is, a RAW image in which only a pixel value of one color of RGB is set in each pixel. Accordingly, the process disclosed in Japanese Unexamined Patent Application Publication No. 2004-127064 may not be applied directly to a RAW image output from an image sensor.

Japanese Unexamined Patent Application Publication Nos. 2005-159916 and 2008-211627 are technologies of the related art that disclose processing methods of reducing noise of a RAW image which has only information regarding one color in each pixel position and is output from an image sensor.

Japanese Unexamined Patent Application Publication No. 2005-159916 discloses a method of performing wavelet transform directly on the RAW image which has only information regarding one color in each pixel position and is output from the image sensor, and then reducing the noise by applying a lowpass filter (LPF).

Japanese Unexamined Patent Application Publication No. 2008-211627 discloses a method of reducing the noise by separating the RAW image output from the image sensor according to the colors of RGB of a Bayer array, performing wavelet shrinkage in signal units of R, G, and B signals, and then generating a luminance signal and a color difference signal.

The wavelet shrinkage corresponds to a process of sequentially performing the following processes:

(a) a wavelet transform (WT),

(b) a coring process, and

(c) a wavelet inverse-transform (WT inverse-transform).

In the noise reduction disclosed in Japanese Unexamined Patent Application Publication Nos. 2005-159916 and 2008-211627, there is a problem that a limit of a noise reduction effect is set according to performance of 2-dimensional wavelet shrinkage. In the process described in Japanese Unexamined Patent Application Publication No. 2008-211627, the noise reduction process is performed separately according to each color of RGB. Since the noise is reduced with no consideration of a correlation between RGB colors, there is a problem that a noise reduction effect decreases.

### SUMMARY

It is desirable to provide an image processing device, an image processing method, and a program performing a noise reduction process by setting a RAW image output from an image sensor of a camera as a processing target, that is, a RAW image in which only information regarding one color is present in each pixel position.

In a process according to an embodiment of the present disclosure, similar local regions are searched for from the periphery of a local region and band separation and a noise reduction process for each band are performed on 3-dimensional data of the local regions. Further, the noise reduction can be realized with high accuracy by combining the local regions subjected to the noise reduction process and reducing noise of an entire image.

According to a first embodiment of the present disclosure, there is provided an image processing device including an image processing unit that sets a RAW image in which a pixel value of a specific color is set in each pixel as an input image and reduces a noise component contained in the input image. The image processing unit includes a local region selection unit that selects each local region of interest as a processing target region from the input image, a similar local region selection unit that selects similar local regions which have the same phase as the local region of interest and have high similarity to the local region of interest, a band separation unit that separates local regions in each of the local region of interest and the similar local regions into band-classified signals including a highpass signal and a lowpass signal, a band-classified noise reduction unit that performs a process of reducing noise contained in the band-classified signals generated in the band separation unit, a band combining unit that combines band-classified signals after the noise reduction generated by the band-classified noise reduction unit to generate noise-reduced local region-of-interest images, and a local region combining unit that sequentially inputs the noise-reduced local region-of-interest images generated by the band combining unit and generates a noise-reduced RAW image through an input image combining process.

Further, the band-classified noise reduction unit may generate 3-dimensional data in which the highpass signals of the local region of interest and the similar local regions are set in XY planes and are superimposed in a Z-axis direction. The band-classified noise reduction unit may perform the noise reduction process on the highpass signal of the local region of interest by sequentially performing the following processes of (a) to (e) applying the 3-dimensional data:

(a) a process of generating a plurality of pieces of 2-dimensional wavelet transform data corresponding to local regions through a 2-dimensional wavelet transform process on the highpass signal of each local region which is XY plane data,

(b) a process of generating a plurality of pieces of 1-dimensional wavelet transform data through a 1-dimensional wavelet transform process on each of 1-dimensional pixel rows in the Z-axis direction generated from the plurality of pieces of 2-dimensional wavelet transform data corresponding to the local regions,

(c) a shrinkage process on each of the plurality of pieces of 1-dimensional wavelet transform data,

(d) a 1-dimensional wavelet inverse-transform process on each of the plurality of pieces of 1-dimensional wavelet transform data after the shrinkage process, and

(e) a 2-dimensional wavelet inverse-transform process on an XY plane signal corresponding to the local region of interest formed by data after the 1-dimensional wavelet inverse-transform process.

Further, the band-classified noise reduction unit may generate 3-dimensional data in which the lowpass signals of the local region of interest and the similar local regions are set in the XY planes and are superimposed in the Z-axis direction. The band-classified noise reduction unit may perform the noise reduction process on the lowpass signal of the local region of interest through an ε filter (epsilon filter) application process on each of the plurality of pieces of 1-dimensional data in the Z-axis direction generated from the 3-dimensional data.

Further, the band-classified noise reduction unit may generate 3-dimensional data in which the lowpass signals of the local region of interest and the similar local regions are set in the XY planes and are superimposed in the Z-axis direction. The band-classified noise reduction unit may perform the noise reduction process on the lowpass signal of the local region of interest by sequentially performing the following processes of (a) to (c) applying the 3-dimensional data:

(a) a process of generating a plurality of pieces of 1-dimensional wavelet transform data through a 1-dimensional wavelet transform process on each of the plurality of pieces of 1-dimensional data in the Z-axis direction generated from the 3-dimensional data,

(b) a shrinkage process on each of the plurality of pieces of 1-dimensional wavelet transform data, and

(c) a 1-dimensional wavelet inverse-transform process on each of the plurality of pieces of 1-dimensional wavelet transform data after the shrinkage process.

Further, the band-classified noise reduction unit may generate 3-dimensional data in which the highpass signals of the local region of interest and the similar local regions are set in XY planes and are superimposed in a Z-axis direction. The band-classified noise reduction unit may perform the noise reduction process on the highpass signal of the local region of interest by sequentially performing the following processes of (a) to (c) applying the 3-dimensional data:

(a) a process of generating a plurality of pieces of 2-dimensional wavelet transform data corresponding to the local regions through a 2-dimensional wavelet transform process on the highpass signal of each local region which is XY plane data,

(b) an ε filter (epsilon filter) application process on each of the 1-dimensional pixel rows in the Z-axis direction generated from the plurality of pieces of 2-dimensional wavelet transform data corresponding to the local regions, and

(c) a 2-dimensional wavelet inverse-transform process on data after the ε filter (epsilon filter) application process.

Further, the band-classified noise reduction unit may generate 3-dimensional data in which the lowpass signals of the local region of interest and the similar local regions are set in the XY planes and are superimposed in the Z-axis direction. The band-classified noise reduction unit may perform the noise reduction process on the lowpass signal of the local region of interest through the ε filter (epsilon filter) application process on each of the plurality of pieces of 1-dimensional data in the Z-axis direction generated from the generated 3-dimensional data.

Further, the band-classified noise reduction unit may generate 3-dimensional data in which the lowpass signals of the local region of interest and the similar local regions are set in the XY planes and are superimposed in the Z-axis direction. The band-classified noise reduction unit may perform the noise reduction process on the lowpass signal of the local region of interest by sequentially performing the following processes of (a) to (c) applying the 3-dimensional data:

(a) a process of generating a plurality of pieces of 1-dimensional wavelet transform data through a 1-dimensional wavelet transform process on each of a plurality of pieces of 1-dimensional data in the Z-axis direction generated from the 3-dimensional data,

(b) a shrinkage process on each of the plurality of pieces of 1-dimensional wavelet transform data, and

(c) a 1-dimensional wavelet inverse-transform process on each of the plurality of pieces of 1-dimensional wavelet transform data after the shrinkage process.

Further, the band-classified noise reduction unit may generate 3-dimensional data in which the highpass signals of the local region of interest and the similar local regions are set in XY planes and are superimposed in a Z-axis direction. The band-classified noise reduction unit may perform the noise reduction process on the highpass signal of the local region of interest through an ε filter (epsilon filter) application process on each of a plurality of pieces of 1-dimensional data in the Z-axis direction generated from the 3-dimensional data.

Further, the band-classified noise reduction unit may generate 3-dimensional data in which the lowpass signals of the local region of interest and the similar local regions are set in the XY planes and are superimposed in the Z-axis direction. The band-classified noise reduction unit may perform the noise reduction process on the lowpass signal of the local region of interest through the ε filter (epsilon filter) application process on each of the plurality of pieces of 1-dimensional data in the Z-axis direction generated from the generated 3-dimensional data.

Further, the band-classified noise reduction unit may generate 3-dimensional data in which the lowpass signals of the local region of interest and the similar local regions are set in the XY planes and are superimposed in the Z-axis direction. The band-classified noise reduction unit may perform the noise reduction process on the lowpass signal of the local region of interest by sequentially performing the following processes of (a) to (c) applying the 3-dimensional data:

(a) a process of generating a plurality of pieces of 1-dimensional wavelet transform data through a 1-dimensional wavelet transform process on each of the plurality of pieces of 1-dimensional data in the Z-axis direction generated from the 3-dimensional data,

(b) a shrinkage process on each of the plurality of pieces of 1-dimensional wavelet transform data, and

(c) a 1-dimensional wavelet inverse-transform process on each of the plurality of pieces of 1-dimensional wavelet transform data after the shrinkage process.

Further, the band separation unit may set an average value in color units of the local regions in each of the local region of interest and the similar local regions as the lowpass signal corresponding to each color in each local region. The band separation unit may calculate the highpass signal corresponding to each pixel in the local regions in each of the local region of interest and the similar local regions according to the following equation:

highpass signal=(pixel value of each pixel)−(color average value corresponding each pixel).

Further, the image processing unit may further include a reference color calculation unit that generates a reference color image in which a reference color pixel value is set at each pixel position of the RAW image based on the RAW image. The similar local region selection unit may determine similarity to the local region of interest applying the reference color image and select similar local regions with high similarity to the local region of interest.

Further, the reference color pixel value may be a luminance value.

Further, the RAW image may be a RAW image with a Bayer array.

Further, the RAW image may be a RAW image with a Bayer array. The band-classified noise reduction unit may generate 3-dimensional data in which band-classified signals of the local region of interest and the similar local regions are set in XY planes and are superimposed in a Z-axis direction. The band-classified noise reduction unit may generate separation data of a luminance signal and another signal by performing a 2-dimensional wavelet transform process on the band-classified signal of each local region which is XY plane data and performs the noise reduction process applying each piece of the generated separation data.

Further, the local region selection unit may sequentially select the local regions of interest as regions including an overlapping pixel region. When the local region combining unit sequentially inputs the noise-reduced local region-of-interest images including the overlapping pixel region and generates the noise-reduced RAW image through an input image combining process, the local region combining unit may perform a process of averaging pixel values of the overlapping pixel region included in the plurality of noise-reduced local region-of-interest images and set a pixel value of the noise-reduced RAW image.

Further, according to a second embodiment of the present disclosure, there is provided an image processing method performed by an image processing unit of an image processing device, the image processing device including an image processing unit that sets a RAW image in which a pixel value of a specific color is set in each pixel as an input image and reduces a noise component contained in the input image, the method including selecting a local region of interest as a processing target region from the input image, selecting similar local regions which have the same phase as the local region of interest and have high similarity to the local region of interest, separating the local regions in each of the local region of interest and the similar local regions into band-classified signals including a highpass signal and a lowpass signal, performing a process of reducing noise contained in the band-classified signals generated in the band separation process, combining band-classified signals after the noise reduction generated in the band-classified noise reduction process to generate noise-reduced local region-of-interest images, and sequentially inputting the noise-reduced local region-of-interest images generated in the band combining process and generating a noise-reduced RAW image through an input image combining process.

Further, according to a third embodiment of the present disclosure, there is provided a program causing an image processing device to perform image processing, the image processing device including an image processing unit that sets a RAW image in which a pixel value of a specific color is set in each pixel as an input image and reduces a noise component contained in the input image, the program causing the image processing unit to perform selecting a local region of interest as a processing target region from the input image, selecting similar local regions which have the same phase as the local region of interest and have high similarity to the local region of interest, separating the local regions in each of the local region of interest and the similar local regions into band-classified signals including a highpass signal and a lowpass signal, performing a process of reducing noise contained in the band-classified signals generated in the band separation process, combining band-classified signals after the noise reduction generated in the band-classified noise reduction process to generate noise-reduced local region-of-interest images, and sequentially inputting the noise-reduced local region-of-interest images generated in the band combining process and generating a noise-reduced RAW image through the input image combining process.

Note that the program according to the present disclosure is a program that can be provided in a storage medium or communication medium that is provided in a computer-readable form for an information processing device or a computer system that is capable of executing various types of program code, for example. Providing this sort of program in a computer-readable form makes it possible to implement the processing according to the program in the information processing device or the computer system.

The object, features, and advantages of the present disclosure will be made clear later by a more detailed explanation that is based on the embodiments of the present disclosure and the appended drawings. Furthermore, the system in this specification is not limited to being a configuration that logically aggregates a plurality of devices, all of which are contained within the same housing.

According to a configuration of an embodiment of the present disclosure, a device and a method for performing the noise reduction process on a RAW image are realized.

Specifically, a local region of interest and similar local regions having the same phase as the local region of interest are selected from the RAW image, each of the local regions is separated into band-classified signals including a highpass signal and a lowpass signal, and a process of reducing noise contained in the band-classified signals is performed. In the noise reduction process, for example, 3-dimensional data in which the highpass signals are set in XY planes and are superimposed in a Z-axis direction is generated and a noise-reduced highpass signal image of the local region of interest is generated by performing a 2-dimensional wavelet transform, a 1-dimensional wavelet transform, a shrinkage process, and 1-dimensional and 2-dimensional wavelet inverse-transforms applying the 3-dimensional data.

Even with regard to the lowpass signals, the noise is reduced through a process of applying an ε filer, a 1-dimensional wavelet transform process, or the like applying 3-dimensional data including the local region of interest and similar local region data.

The RAW image in which the noise is reduced is generated by combining the bands of the highpass signals and the lowpass signals in which the noise is reduced, generating the noise-reduced images corresponding to the local regions of interest, and combining the noise-reduced images of the local regions of interest.

In the process according to an embodiment of the present disclosure, the noise reduction process on a RAW image is realized with high accuracy.

### BRIEF DESCRIPTION OF THE DRAWINGS

FIG. 1 is a diagram illustrating an example of the configuration of an imaging device of an image processing device according to an embodiment the present disclosure;

FIG. 2 is a diagram illustrating the configuration of an image sensor;

FIG. 3 is a diagram illustrating an example of the configuration and an example of a process of an image processing unit of the image processing device according to an embodiment of the present disclosure;

FIG. 4 is a diagram illustrating an example of the configuration and an example of a process of a RAW noise reduction unit of the image processing unit;

FIG. 5 is a diagram illustrating a similar local region searching process performed by the image processing device;

FIG. 6 is a diagram illustrating a band separation process performed by the image processing device according to an embodiment of the present disclosure;

FIG. 7 is a diagram illustrating an example of a data structure applied to the noise reduction process performed by the image processing device according to an embodiment of the present disclosure;

FIG. 8 is a flowchart illustrating a sequence of the noise reduction process performed by the image processing device according to an embodiment of the present disclosure;

FIG. 9 is a diagram illustrating a 2-dimensional wavelet transform process performed by the image processing device according to an embodiment of the present disclosure;

FIG. 10 is a diagram illustrating a 2-dimensional wavelet transform process performed by the image processing device according to an embodiment of the present disclosure;

FIG. 11 is a diagram illustrating a 1-dimensional wavelet transform process performed by the image processing device according to an embodiment of the present disclosure;

FIG. 12 is a diagram illustrating a 1-dimensional wavelet transform process performed by the image processing device according to an embodiment of the present disclosure;

FIG. 13 is a diagram illustrating a shrinkage process performed by the image processing device according to an embodiment of the present disclosure;

FIG. 14 is a diagram illustrating noise characteristics of an image sensor;

FIG. 15 is a diagram illustrating characteristics of a 2-dimensional wavelet transform process performed by the image processing device according to an embodiment of the present disclosure;

FIG. 16 is a diagram illustrating characteristics of a 2-dimensional wavelet transform process performed by the image processing device according to an embodiment of the present disclosure;

FIG. 17 is a flowchart illustrating a sequence of a noise reduction process performed by the image processing device according to an embodiment of the present disclosure;

FIG. 18 is a flowchart illustrating a sequence of a noise reduction process performed by the image processing device according to an embodiment of the present disclosure;

FIG. 19 is a flowchart illustrating a sequence of a noise reduction process performed by the image processing device according to an embodiment of the present disclosure;

FIG. 20 is a flowchart illustrating a sequence of a noise reduction process performed by the image processing device according to an embodiment of the present disclosure;

FIG. 21 is a diagram illustrating a specific example of a local region combining process performed by the image processing device according to an embodiment of the present disclosure;

FIG. 22 is a flowchart illustrating a whole sequence of a noise reduction process performed by the image processing device according to an embodiment of the present disclosure;

FIG. 23 is a diagram illustrating an example of the configuration and an example of a process of a RAW noise reduction unit of the image processing unit;

FIG. 24 is a diagram illustrating a process performed by a reference color calculation unit of the RAW noise reduction unit of the image processing unit;

FIG. 25 is a diagram illustrating a process performed by the reference color calculation unit of the RAW noise reduction unit of the image processing unit;

FIG. 26 is a flowchart illustrating a whole sequence of a noise reduction process performed by the image processing device according to an embodiment of the present disclosure;

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, an image processing device, an image processing method, and a program according to embodiments of the present disclosure will be described in detail with reference to the drawings. The description will be made in the order of the following sections.

1. Example of configuration and example of process of image processing device

1-1. Configuration of image processing device

1-2. Process of image processing device

2. First embodiment of noise reduction process performed by image processing device according to embodiments of the present disclosure

2-1. Example of entire configuration of image processing unit

2-2. Configuration and process of RAW noise reduction unit

2-3. Process of local region selection unit

2-4. Process of similar local region selection unit

2-5. Process of band separation unit

2-6. Process of highpass noise reduction unit

2-6-1. (1st processing example) Noise reduction process by 3-dimensional wavelet shrinkage

2-6-2. (2nd processing example) Noise reduction process by 2-dimensional wavelet+ε filter (epsilon filter)

2-6-3. (3rd processing example) Noise reduction process by ε filter (epsilon filter) of Z direction

2-7. Process of lowpass noise reduction unit

2-7-1. (1st processing example) Noise reduction process by 1-dimensional wavelet shrinkage

2-7-2. (2nd processing example) Noise reduction process of applying filter (epsilon filter) to each 1-dimensional data including average (DC) signal of same color (R, G, or B) in units of local regions

2-8. Process of band combining unit

2-9. Process of local region combining unit

3. Whole sequence of noise reduction process

4. Second embodiment of noise reduction process performed by image processing device according to embodiments of the present disclosure

5. Sequence of noise reduction process according to second embodiment

6. Summarization of configuration according to embodiments of the present disclosure

[1. Example of Configuration and Example of Process of Image Processing Device]

First, an example of the configuration and an example of a process of an image processing device according to embodiments of the present disclosure will be described.

[1-1. Configuration of Image Processing Device]

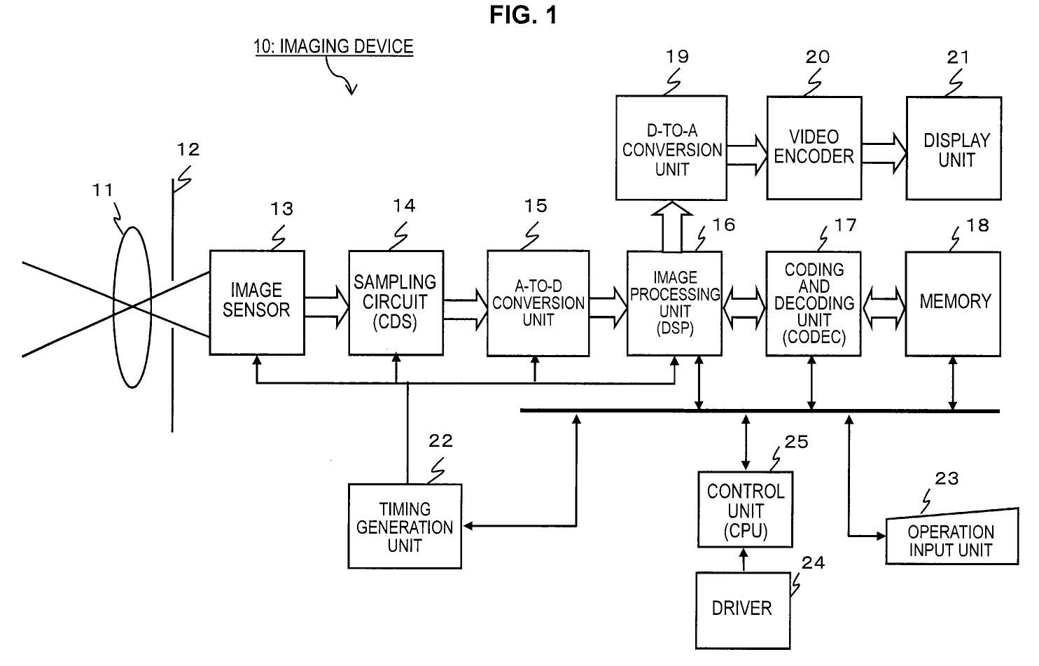

FIG. 1 is a diagram illustrating an example of the configuration of an imaging device 10 which is an example of an image processing device according to an embodiment of the present disclosure. The imaging device 10 mainly includes an optical system, a signal processing system, a recording system, a display system, and a control system.

The optical system includes a lens 11 that condenses a light image of a subject, a diaphragm 12 that adjusts an amount of light of the light image from the lens 11, and an image sensor 13 that performs photoelectric conversion on the condensed light image to convert the light image into an electric signal.

The image sensor 13 is, for example, a charge coupled device (CCD) image sensor or a complementary metal oxide semiconductor (CMOS) image sensor.

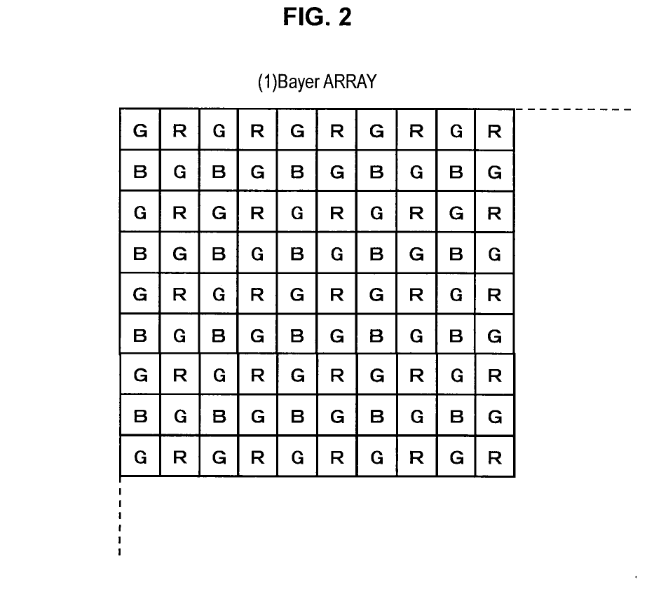

For example, as illustrated in FIG. 2, the image sensor 13 is an image sensor that has a color filter with a Bayer array including RGB pixels.

A pixel value corresponding to one color of RGB according to the array of the color filter is set in each pixel.

The array illustrated in FIG. 2 is an example of a pixel array of the image sensor 13. The image sensor 13 may be configured to have other various set arrays.

Referring back to FIG. 1, the configuration of the imaging device 10 will be continuously described.

The signal processing system includes a sampling circuit 14, an analog-to-digital (A-to-D) conversion unit 15, and an image processing unit (DSP) 16.

For example, the sampling circuit 14 is realized by a correlated double sampling (CDS) circuit and samples an electric signal from the image sensor 13 to generate an analog signal. Thus, noise occurring in the image sensor 13 is reduced. The analog signal obtained by the sampling circuit 14 is an image signal generated to display a captured image of a subject.

The A-to-D conversion unit 15 converts the analog signal supplied from the sampling circuit 14 into a digital signal and supplies the converted digital signal to the image processing unit 16.

The image processing unit 16 performs predetermined image processing on the digital signal input from the A-to-D conversion unit 15.

Specifically, image data (RAW image) formed from data with a pixel value of one color of RGB described above with reference to FIG. 2 in units of pixels is input and a noise reduction process or the like is performed to reduce noise contained in the input RAW image.

The noise reduction process will be described in detail below.

The image processing unit 16 performs not only the noise reduction process but also signal processing in general cameras, such as a demosaicing process of setting a pixel value corresponding to all colors of RGB in each pixel position of the RAW image, white balance (WB) adjustment, or gamma correction.

The recording system includes a coding and decoding unit 17 that codes or decodes the image signal and a memory 18 that records the image signal.

The coding and decoding unit 17 codes the image signal which is a digital signal processed by the image processing unit 16 and records the image signal in the memory 18. The coding and decoding unit reads and decodes the image signal from the memory 18 and supplies the image signal to the image processing unit 16.

The display system includes a digital-to-analog (D-to-A) conversion unit 19, a video encoder 20, and a display unit 21.

The D-to-A conversion unit 19 converts the image signal processed by the image processing unit 16 into an analog signal, supplies the analog signal to the video encoder 20. The video encoder 20 encodes the image signal from the D-to-A conversion unit 19 into a video signal with a format suitable for the display unit 21.

The display unit 21 is realized by, for example, a liquid crystal display (LCD) and displays an image corresponding to the video signal based on the video signal obtained through the encoding by the video encoder 20. The display unit 21 also functions as a finder when a subject is imaged.

The control system includes a timing generation unit 22, an operation input unit 23, a driver 24, and a control (CPU) 25. The image processing unit 16, the coding and decoding unit 17, the memory 18, the timing generation unit 22, the operation input unit 23, and the control unit 25 are connected to each other via a bus 26.

The timing generation unit 22 controls timings of processes of the image sensor 13, the sampling circuit 14, the A-to-D conversion unit 15, and the image processing unit 16. The operation input unit 23 includes a button, a switch, or the like, receives a shutter operation or another command input of a user, and supplies a signal according to the user's operation to the control unit 25.

A predetermined peripheral device is connected to the driver 24. Then, the driver 24 drives the connected peripheral device. For example, the driver 24 reads data from a recording medium such as a magnetic disk, an optical disc, a magneto-optical disc, or a semiconductor memory connected as a peripheral device and supplies the data to the control unit 25.

The control unit 25 controls the entire imaging device 10. For example, the control unit 25 includes a CPU having a program execution function, reads a control program from a recording medium connected to the driver 24 via the memory 18 or the driver 24, and controls a process of the entire imaging device 10 based on the control program, a command from the operation input unit 23, or the like.

[1-2. Process of Image Processing Device]

Next, a process of the imaging device 10 illustrated in FIG. 1 will be described.

The imaging device 10 allows incident light from a subject, that is, light image of the subject to be incident on the image sensor 13 via the lens 11 and the diaphragm 12 and allows the image sensor 13 to perform photoelectric conversion on the light image to generate an electric signal.

After the sampling circuit 14 removes a noise component from the electric signal obtained by the image sensor 13 and the A-to-D conversion unit 15 converts the electric signal into a digital signal, the digital signal is temporarily stored in an image memory such as a frame buffer (not illustrated) included in the image processing unit 16.

In a normal state, that is, in a state before a shutter operation is performed, an image signal from the A-to-D conversion unit 15 is continually overwritten at a constant frame rate in the image memory (frame buffer) of the image processing unit 16 under control of a timing on the signal processing system by the timing generation unit 22. The image signal in the image memory of the image processing unit 16 is converted from the digital signal to an analog signal by the D-to-A conversion unit 19, the analog signal is converted into a video signal by the video encoder 20, and an image corresponding to the video signal is displayed on the display unit 21.

The display unit 21 also has a role of the function of a finder of the imaging device 10. Thus, the user determines a composition, while viewing an image displayed on the display unit 21, and presses the shutter button serving as the operation input unit 23 to give an instruction to capture an image.

When the shutter button is pressed, the control unit 25 instructs the timing generation unit 22 to maintain the image signal immediately after the shutter button is pressed based on a signal from the operation input unit 23. Thus, the signal processing system is controlled such that the image signal is not overwritten in the image memory of the image processing unit 16.

Thereafter, the image processing unit 16 performs signal processing on the image signal maintained in the image memory, for example, various kinds of signal processing such as a noise reduction process, a demosaicing process, and a white balance adjustment process, and then outputs the processed image data to the coding and decoding unit 17.

The coding and decoding unit 17 codes the image data input from the image processing unit 16 and records the image data in the memory 18. The acquisition of one image signal is completed through the above-described process of the imaging device 10.

[2. First Embodiment of Noise Reduction Process Performed by Image Processing Device According to an Embodiment of the Present Disclosure]

Next, a first embodiment of the noise reduction process performed by the image processing unit 16 of the imaging device according to an embodiment of the present disclosure will be described.

[2-1. Example of Entire Configuration of Image Processing Unit]

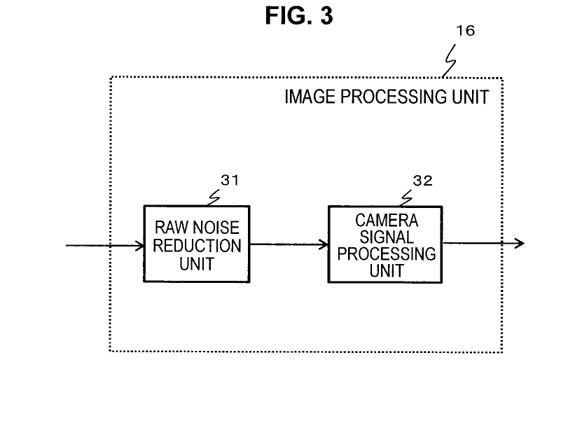

FIG. 3 is a diagram illustrating an example of the configuration of the image processing unit 16 of the imaging device 10 in FIG. 1.

A RAW noise reduction unit 31 inputs an image (RAW image) captured by the image sensor 13 with a color filter array which is, for example, the array described with reference to FIG. 2, performs a noise reduction process without changing the color array (a color at each pixel position), and generates and outputs the noise reduced RAW image.

Since the noise reduction process performed by the RAW noise reduction unit 31 can be performed as a process on an output from the image sensor 13, the noise reduction process can be performed as a process using previously acquirable noise characteristics of the image sensor 13.

When the noise is reduced after the demosaicing or other signal processing, it is difficult to estimate the noise characteristics of an image subjected to the signal processing. Therefore, there is a problem that it is difficult to effectively reduce the noise according to the characteristics.

A camera signal processing unit 32 inputs a color-array image from which the noise is reduced by the RAW noise reduction unit 31, performs a demosaicing process of restoring all of the colors in the respective pixels through signal processing or other general camera signal processing, and generates and outputs an output image.

[2-2. Configuration and Process of RAW Noise Reduction Unit]

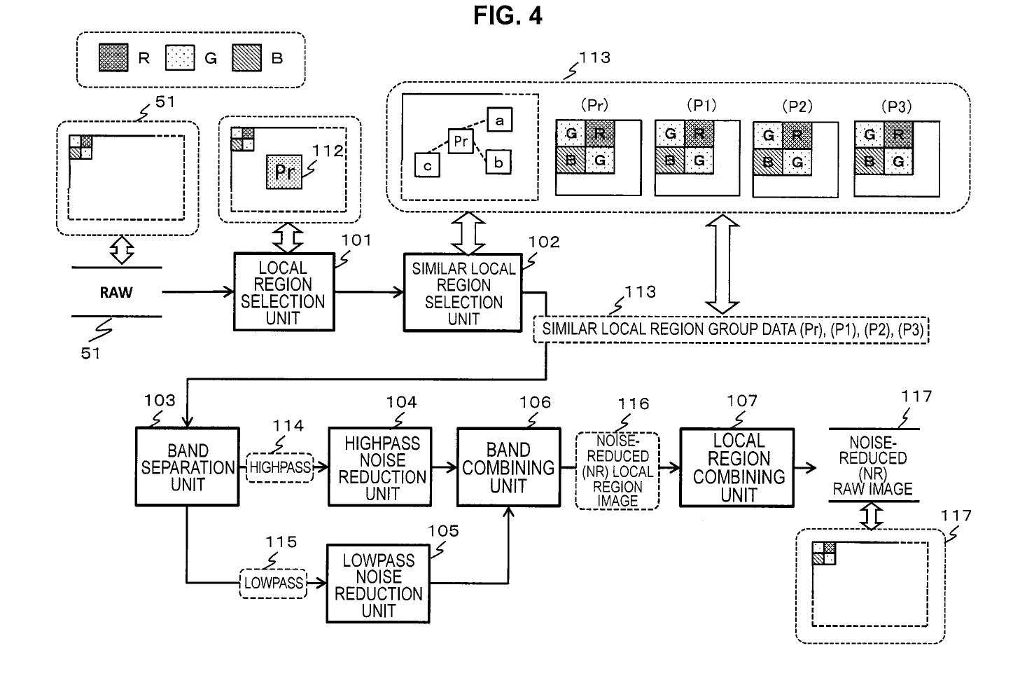

FIG. 4 is a diagram illustrating a detailed configuration and a process of the RAW noise reduction unit 31 of the image processing unit 16 illustrated in FIG. 3.

A RAW image 51 is input from the A-to-D conversion unit 15 of the imaging device 10 illustrated in FIG. 1 to the RAW noise reduction unit 31 of the image processing unit 16.

The RAW image 51 is an image in which only a pixel value of one of RGB is set in each pixel. Here, the description will be made assuming that the RAW image 51 with a pixel array according to the Bayer array illustrated in FIG. 2 is input.

[2-3. Process of Local Region Selection Unit]

The RAW image 51 is input to a local region selection unit 101 of the RAW noise reduction unit 31.

The local region selection unit 101 inputs the image captured by the image sensor 13 with a specific color filter array, for example, the color array illustrated in FIG. 2, and sequentially selects given local regions, for example, rectangular regions with n×n pixels as regions of interest (local region of interest Pr112) which are noise reduction processing targets. Here, n is an integer equal to or greater than 2.

Image information regarding the local region of interest selected as a processing target by the local region selection unit 101 is input together with the RAW image 51 to a similar local region selection unit 102.

[2-4. Process of Similar Local Region Selection Unit]

The similar local region selection unit 102 searches for local regions with high similarity to the local region of interest Pr112 selected as the noise reduction processing target by the local region selection unit 101, that is, similar regions (similar local regions) among peripheral regions.

The similar local regions selected by the similar local region selection unit 102 are pixel regions with the same phase as the local region of interest Pr112 selected the noise reduction processing target by the local region selection unit 101, that is, pixel regions of which color arrays are the same, and a plurality of local regions with high similarity are searched for and selected from the peripheral regions.

The similar local region selection unit 102 selects a plurality of similar local regions by a preset number in order from the most similar to the local region of interest Pr112.

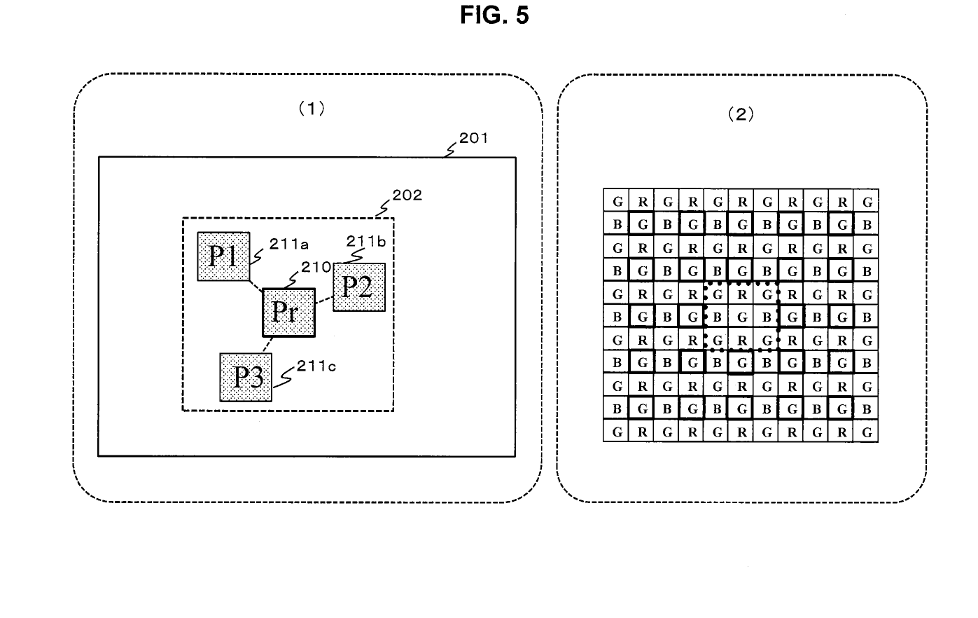

FIG. 5 is a diagram illustrating a similar local region searching process performed by the similar local region selection unit 102.

As illustrated in FIG. 5(1), for example, the similar local region selection unit 102 searches for and extracts a predetermined number of local regions Pi (where i=1, 2, 3, . . . ) with high similarity due to the same phase as the local region of interest Pr210 from a search region 202 set centering on the local region of interest Pr210 and selected as a noise reduction processing target region by the local region selection unit 101 in order from the most similar.

FIG. 5(1) illustrates an example in which three similar local regions P1-211a, P2-211b, and P3-211c are extracted.

FIG. 5(2) is a diagram illustrating a search example when the color array is a Bayer array. For example, 3×3 pixels which are indicated by a thick dotted line of the drawing and center on a G pixel located at the center illustrated in FIG. 5(2) are set as a local region of interest selected by the local region selection unit 101. The phase of this local region, that is, a color array, is as follows:

GRG,

BGB, and

GRG.

The search region is set in the periphery of the local region of interest. For example, the search region is assumed to be an 11×11 pixel region illustrated in FIG. 5(2). A region searched for in this search region is a local region with the same phase as the local region of interest. That is, a local region with the following phase is an extraction target:

GRG,

BGB, and

GRG.

Accordingly, actual search targets in a search range are twenty-four 3×3 pixel regions centering on the G pixels indicated by thick solid lines.

The preset number of local regions with high similarity to the local region of interest is selected from the twenty-four similar local region candidates.

With regard to the similarity of the local regions, for example, Sum of Absolute Differences (SAD) or Sum of Squares Differences (SSD) based on pixel values between the local regions is used. The local regions that have a small value of the SAD or the SSD with the local region of interest are sequentially selected.

The sum of absolute differences (R_{SAD}) between two local regions is calculated using the following (Equation 1).

R_{SAD}=ΣΣ|Pr(x,y)−Pi(x,y)| (Equation 1)

In the foregoing (Equation 1), Pr(x, y) is a pixel value of the coordinates of the local region of interest and Pi(x, y) is a pixel value of the coordinates (x, y) of the similar local region.

The sum of squares differences (R_{SSD}) between two local regions is calculated using the following (Equation 2).

R_{SSD}=ΣΣ(Pr(x,y)−Pi(x,y))² (Equation 2)

In the foregoing (Equation 2), Pr(x, y) is a pixel value of the coordinates of the local region of interest and Pi(x, y) is a pixel value of the coordinates (x, y) of the similar local region.

Sum of Absolute Differences (SAD) or Sum of Squares Differences (SSD) is an index indicating that the similarity is higher as its value is smaller.

As described with reference to FIG. 5, the similar local region selection unit 102 searches for and extracts the predetermined number of local regions Pi (where i=1, 2, 3, . . . ) with high similarity due to the same phase as the local region of interest Pr210 from the search region 202 set centering on the local region of interest Pr210 and selected as a noise reduction processing target region by the local region selection unit 101 in order from the most similar.

The similar local region selection unit 102 outputs image information regarding the extracted similar local regions together with the image information regarding the local region of interest selected as a noise reduction processing target region by the local region selection unit 101 as similar local region group data 113, as illustrated in FIG. 4, to a band separation unit 103.

[2-5. Process of Band Separation Unit]

The band separation unit 103 inputs the similar local region group data 113 including a plurality of similar local region images with the same phase from the similar local region selection unit 102.

The band separation unit 103 calculates a highpass component and lowpass component of each of these local regions and outputs a highpass component 114 and a lowpass component 115 to a highpass noise reduction unit 104 and a lowpass noise reduction unit 105, respectively.

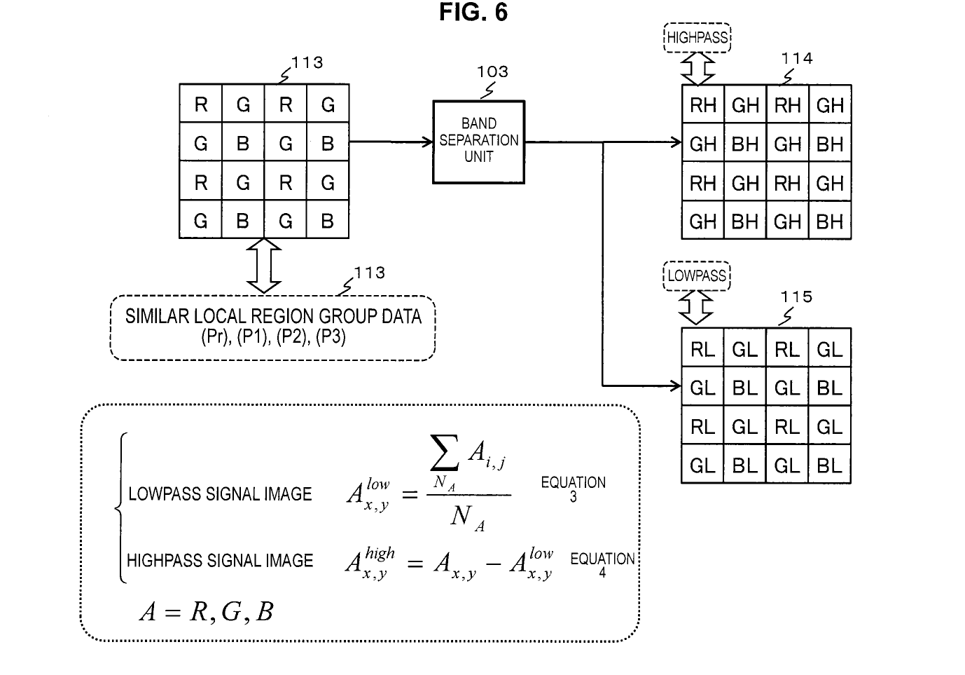

A band separation process performed by the band separation unit 103 will be described with reference to FIG. 6.

As illustrated in FIG. 4, the band separation unit 103 inputs the similar local region group data 113 from the similar local region selection unit 102. The similar local region group data 113 includes image data of the local region of interest, which is a noise reduction processing target region selected by the local region selection unit 101, and the similar local regions selected by the similar local region selection unit 102. The similar local region is a local region which has the same phase as the local region of interest and is similar thereto.

FIG. 6 illustrates an example of local region data including 4×4 pixels as one piece of local region data of the similar local region group data 113. The local region of 4×4 pixels is the local region of interest or the similar local region.

The band separation unit 103 performs the same process on each of the local region of interest and the plurality of similar local regions to generate highpass signal image data 114 and lowpass signal image data 115 corresponding to each local region and outputs the highpass signal image data 114 and the lowpass signal image data 115 to the highpass noise reduction unit 104 and the lowpass noise reduction unit 105, respectively, as illustrated in FIG. 4.

For example, when three similar local regions are selected as similar local regions corresponding to one local region of interest, the band separation unit 103 performs the same band separation process on a total of four local regions to generate four highpass signal images and four lowpass signal images and outputs the highpass signal images and lowpass signal images to the highpass noise reduction unit 104 and the lowpass noise reduction unit 105, respectively.

As illustrated in FIG. 6, the band separation unit 103 generates the highpass signal image data 114 and the lowpass signal image data 115 having the same pixel array as the local region data to be subjected to the band separation process. In the highpass signal image data 114 illustrated in FIG. 6, RH, GH, and BH indicate a highpass signal of R, a highpass signal of G and a highpass signal of B, respectively, and are signal values (pixel values) corresponding to the highpass signals of the colors of RGB, respectively.

Likewise, in the lowpass signal image data 115 illustrated in FIG. 6, RL, GL, and BL indicate a lowpass signal of R, a lowpass signal of G, and a lowpass signal of B, respectively, and are signal values (pixel values) corresponding to the lowpass signals of the colors of RGB, respectively.

Thus, the band separation unit 103 generates and outputs the highpass signal image data 114 and the lowpass signal image data 115 with the same pixel array as an input signal.

As described above, since the band separation process is performed on each of the local regions, the highpass signal image data 114 and the lowpass signal image data 115 are generated and output for each of the local region of interest and the similar local regions included in the similar local region group data 113. The band separation unit 103 calculates each pixel value (A^{low}_{x, y}) of the lowpass signal image data 115 of each of the local region of interest and the similar local regions and each piece of local region image data included in the similar local region group data 113 according to the following (Equation 3) and calculates each pixel value (A^{high}_{x, y}) of the highpass signal image data 114 according to the following (Equation 4).

$$\begin{matrix}{A}_{x , y}^{low} = \frac{{\sum }_{{N}_{A}}^{ } {A}_{i , j}}{{N}_{A}} \\ A = R , G , B & ( Equation 3 ) \\ {A}_{x , y}^{high} = {A}_{x , y} - {A}_{x , y}^{low} \\ A = R , G , B & ( Equation 4 )\end{matrix}$$

Here, in the foregoing (Equation 3) and (Equation 4), the parameters are as follows:

A: each pixel color of an image to be processed and one of R, G, and B in the case of the Bayer array,

A_{x, y}: a pixel value at a position of the coordinates (x, y) of an input local region image to be processed,

N_{A}: the number of pixels of a color A included in the input local region image to be processed,

A^{low}_{x, y}: a pixel value at a position of the coordinates (x, y) of the lowpass signal image data, and

A^{high}_{x, y}: a pixel value at a position of the coordinates (x, y) of the highpass signal image data.

The foregoing (Equation 3) is an equation used to calculate an average (DC component) of every RGB in the local region as a lowpass signal value (A^{low}_{x, y}). In the case of the Bayer array, since there are three colors RGB, lowpass signal values of RGB are calculated in units of local regions according to the foregoing (Equation 3).

The foregoing (Equation 4) is the following calculation equation.

highpass signal value=(input pixel value)−(lowpass signal value calculated using Equation 3)

The highpass signal value is calculated as a unique pixel value of each pixel of the local region, that is, a highpass signal value corresponding to a pixel.

According to the calculation equations of the foregoing (Equation 3) and (Equation 4), the highpass signal components are output by the number of pixels of the local region. On the other hand, the lowpass components become only three values of RGB. Thus, with regard to the lowpass components, it is not necessary to perform the calculation process by the number of pixels, and the lowpass signal image data 115 can be generated merely by performing the calculation process of each of RGB, that is, the calculation process a total of three times. Accordingly, reduction of a memory capacity and reduction in a calculation cost are realized.

With regard to the lowpass signal components, not only the average value in the local region expressed in the foregoing (Equation 3) may be calculated, but the calculation may be also performed applying, for example, a lowpass filter.

Thus, the band separation unit 103 generates and outputs the highpass signal image data 114 and the lowpass signal image data 115 of each of the local region of interest and the similar local regions included in the similar local region group data 113 using, for example, the foregoing (Equation 3) and (Equation 4).

The highpass signal image data of the local region of interest and the similar local regions is input to the highpass noise reduction unit 104.

On the other hand, the lowpass signal image data of the local region of interest and the similar local regions is input to the lowpass noise reduction unit 105.

[2-6. Process of Highpass Noise Reduction Unit]

The highpass noise reduction unit 104 performs a process of reducing noise contained in a highpass component of the local region of interest using the highpass signal image data of the local region of interest and the similar local regions input from the band separation unit 103.

The highpass noise reduction unit 104 inputs the highpass signal image corresponding to one local region of interest and n highpass signal images corresponding to n similar local regions, that is, n+1 highpass signal images from the band separation unit 103.

The highpass noise reduction unit 104 sets the n+1 images collectively as 3-dimensional data and reduces noise from the 3-dimensional data.

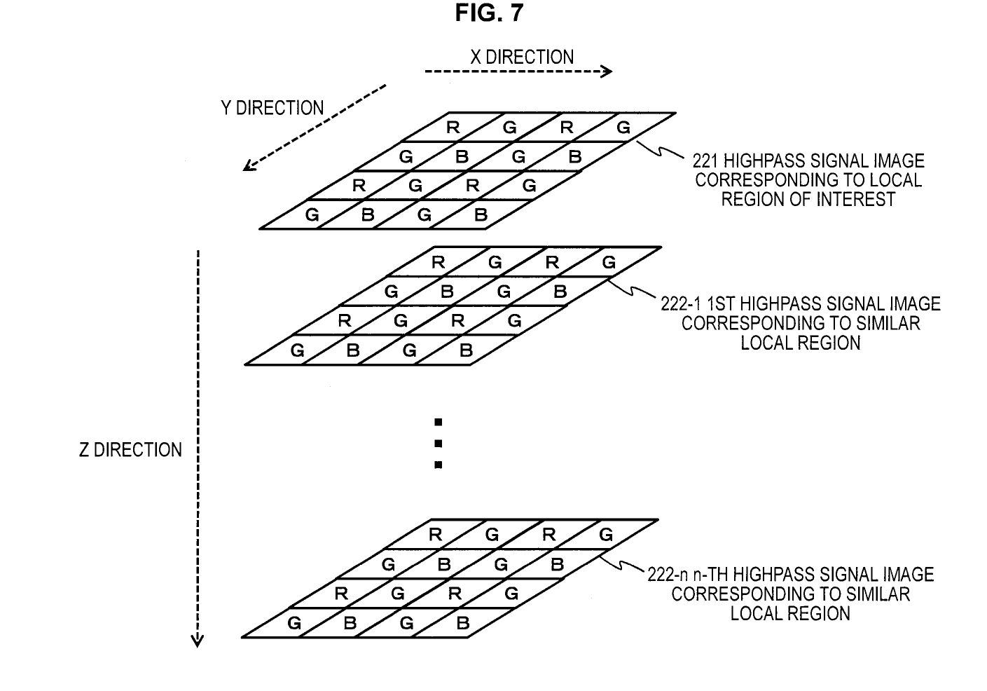

A concept of the 3-dimensional data generated by the highpass noise reduction unit 104 will be described with reference to FIG. 7.

As illustrated in FIG. 7, the highpass noise reduction unit 104 sets planes of highpass signal images corresponding to local regions as XY planes for one highpass signal image 221 corresponding to the local region of interest and n highpass signal images 222-1 to 222-n corresponding to the similar local region input from the band separation unit 103, that is, a total of n+1 images, and generates the 3-dimensional data in which the plurality of highpass signal images are superimposed in the Z-axis direction.

FIG. 7 illustrates an example in which the n+1 highpass signal images corresponding to the local regions of 4×4 pixels are superimposed in the Z-axis direction.

The highpass noise reduction unit 104 performs the noise reduction process using the 3-dimensional data including the highpass signal images corresponding to the plurality of local regions.

Various methods can be applied as the noise reduction process performed by the highpass noise reduction unit 104. Hereinafter, a plurality of examples of the noise reduction process applicable to the highpass noise reduction unit 104 will be described. The following processing examples will be described in order:

(1st1st processing example) a noise reduction process by 3-dimensional wavelet shrinkage,

(2nd processing example) a noise reduction process by 2-dimensional wavelet transform+an ε filter (epsilon filter), and

(3rd processing example) a noise reduction process by the ε filter (epsilon filter) of a Z direction.

[2-6-1. (1st1st Processing Example) Noise Reduction Process by 3-Dimensional Wavelet Shrinkage]

First, a noise reduction process by 3-dimensional wavelet shrinkage will be described as the 1st processing example.

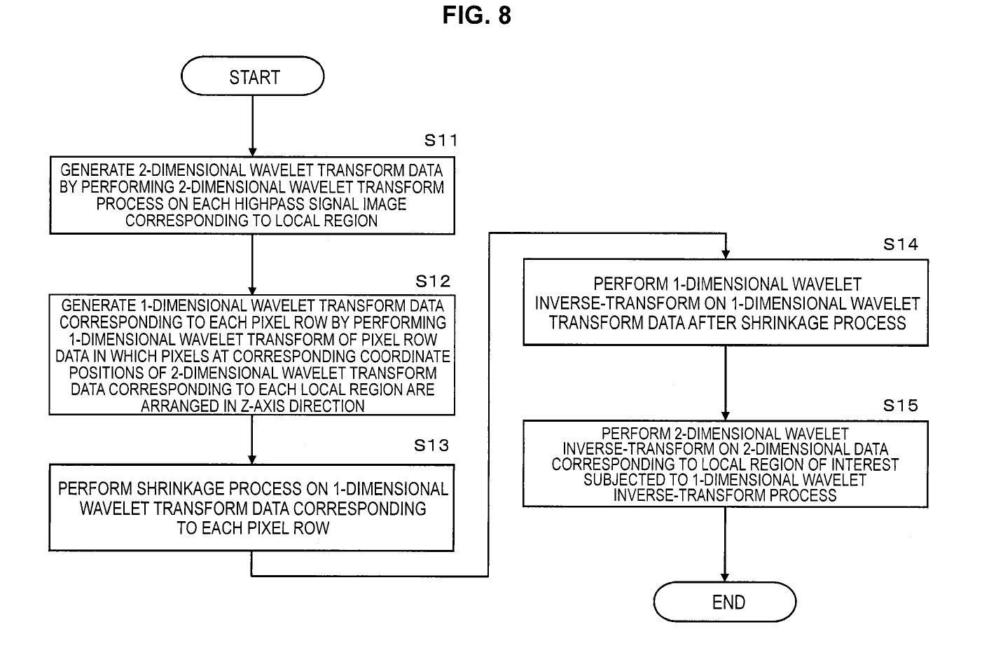

A processing sequence of the first processing example will be described with reference to the flowchart illustrated in FIG. 8. In the 1st processing example, noise reduction is realized by performing a processing order illustrated in FIG. 8, that is, step S11 to step S15.

First, after a series of processes is described simply according to the flow, the details of the processes will be described.

(S11) First, 2-dimensional wavelet transform data in units of highpass signal images corresponding to the local regions is generated by performing a 2-dimensional wavelet transform on a highpass signal image corresponding to each local region of the 3-dimensional data illustrated in FIG. 7, that is, each XY plane.

(S12) Next, a 1-dimensional wavelet transform is performed on a pixel row in which pixels at the same XY position of the 2-dimensional wavelet transform data in the units of the highpass signal images corresponding to the local regions generated in S11 are arranged in the Z-axis direction.

Through this process, 1-dimensional wavelet transform data corresponding to each pixel is generated.

(S13) A shrinkage process is performed on the 1-dimensional wavelet transform data generated in step S12.

(S14) A 1-dimensional wavelet inverse-transform is performed on the 1-dimensional wavelet transform data after the shrinkage process performed in step S13.

(S15) 2-dimensional wavelet inverse-transform is performed on XY plane data corresponding to the local region reconstructed from 1-dimensional wavelet inverse-transform data obtained by performing step S14.

The highpass signal image data corresponding to the local region of interest from which the noise is reduced is generated by performing the series of processes of step S11 to step S15 and reducing the noise contained in the highpass signal of the local region of interest.

Hereinafter, the details of the processes of the steps will be described.

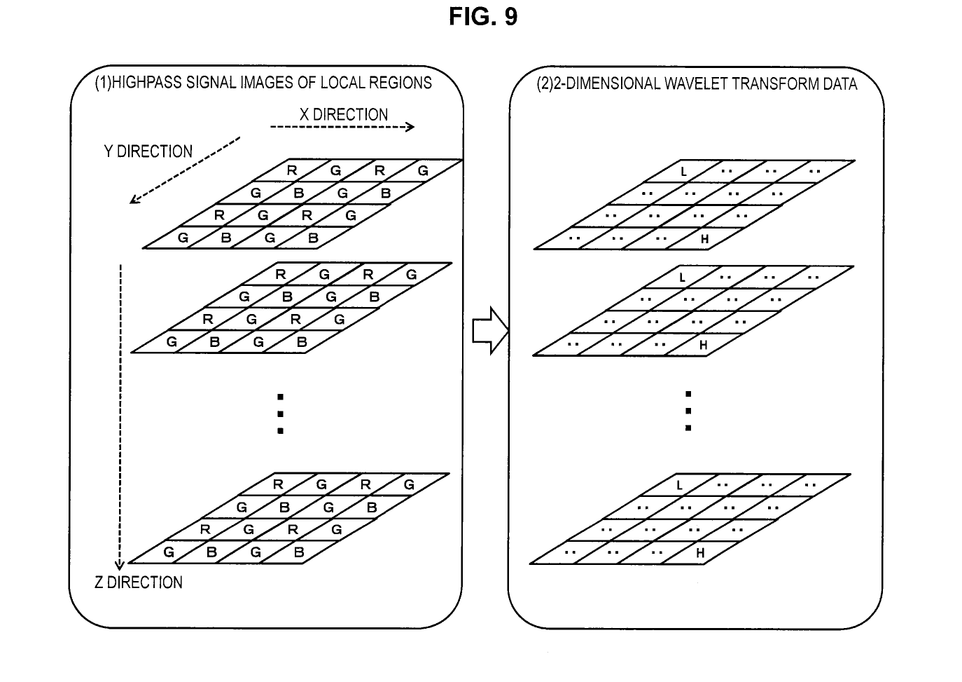

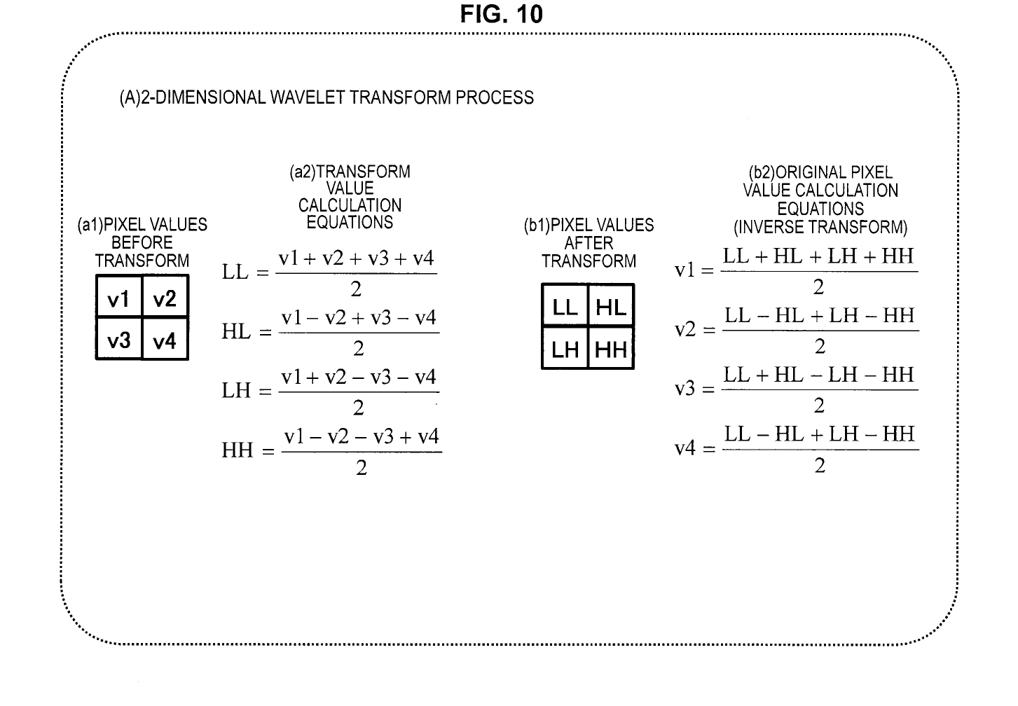

First, the process of step S11 will be described with reference to FIG. 9 and FIG. 10.

In step S11, the 2-dimensional wavelet transform is performed on the 3-dimensional data described with reference to FIG. 7, that is, the highpass signal images corresponding to the local regions, which are arranged as the XY plane in the Z direction by setting the highpass signal image corresponding to each local region, for each highpass signal image of each local region.

FIG. 9 is a diagram illustrating the 2-dimensional wavelet transform process.

FIG. 9(1) illustrates the highpass signal images of the same local regions as those illustrated in FIG. 7. The 2-dimensional wavelet transform is performed on each of the highpass signal images of the local regions to generate 2-dimensional wavelet transform data illustrated in FIG. 9(2).

The wavelet transform process is a process of separating frequency component data of an image and separating the image into signals in predetermined units of frequency components.

In the 2-dimensional wavelet transform, this process is performed on a 2-dimensional image. FIG. 10 is a diagram illustrating a processing example of the 2-dimensional Haar wavelet transform process which is an example of the 2-dimensional wavelet transform process.

For example, as illustrated in FIG. 10(a1), there are 4 pixel regions. When the pixel values of the pixels are v1 to v4, values LL, HL, LH, and HH illustrated in FIG. 10(b1) are set as values after the transform through the 2-dimensional wavelet transform process. Each of the values is referred to as a “development coefficient.”

As illustrated in FIG. 10(a2), the values (development coefficients) LL to HH after the transform are calculated using the following equations based on the pixel values v1 to v4 before the transform:

LL=(v1+v2+v3+v4)/2,

HL=(v1−v2+v3−v4)/2,

LH=(v1+v2−v3−v4)/2, and

HH=(v1−v2−v3+v4)/2.

In the example illustrated in FIG. 10, the process for 2×2 pieces of pixel data, that is, 4 pieces of pixel data, has been described. However, when the process is performed on an image with a plurality of pixels such as 4×4 pixels, for example, a 2-level process is performed in such a manner that the transform according to the foregoing calculation equations is performed in units of 2×2 pixels as a 1st level process, and then the process according to the foregoing calculation equations is performed on 1st level transform data again as a 2nd level process. In this way, the same transform process may be configured to be performed repeatedly.

The data in which the signals LL to HH in the units of the frequency components are set is referred to as 2-dimensional wavelet transform data. The data illustrated in FIG. 10(b1) is an example of the 2-dimensional wavelet transform data.

Equations used to calculate the original v1 to v4 from the signals of the development coefficients LL to HH which are elements of the 2-dimensional wavelet transform data are the following equations, as illustrated in FIG. 10(b2):

v1=(LL+HL+LH+HH)/2,

v2=(LL−HL+LH−HH)/2,

v3=(LL+HL−LH−HH)/2, and

v4=(LL−HL+LH−HH)/2.

The process according to the equations corresponds to the 2-dimensional wavelet inverse-transform (2-dimensional Haar wavelet transform).

In step S15 illustrated in FIG. 8, the 2-dimensional wavelet inverse-transform is performed according to the foregoing equations.

The values calculated through the 2-dimensional wavelet inverse-transform in step S15 illustrated in FIG. 8 are the original input values, that is, values different from the highpass signals corresponding to the local regions to be processed in step S11.

This is because the values are changed due to the shrinkage process of step S13. The noise components are removed through the shrinkage process, and thus the highpass signal images generated through the 2-dimensional wavelet inverse-transform of step S15 are images in which highpass signal values obtained after the removal of the noise components are set.

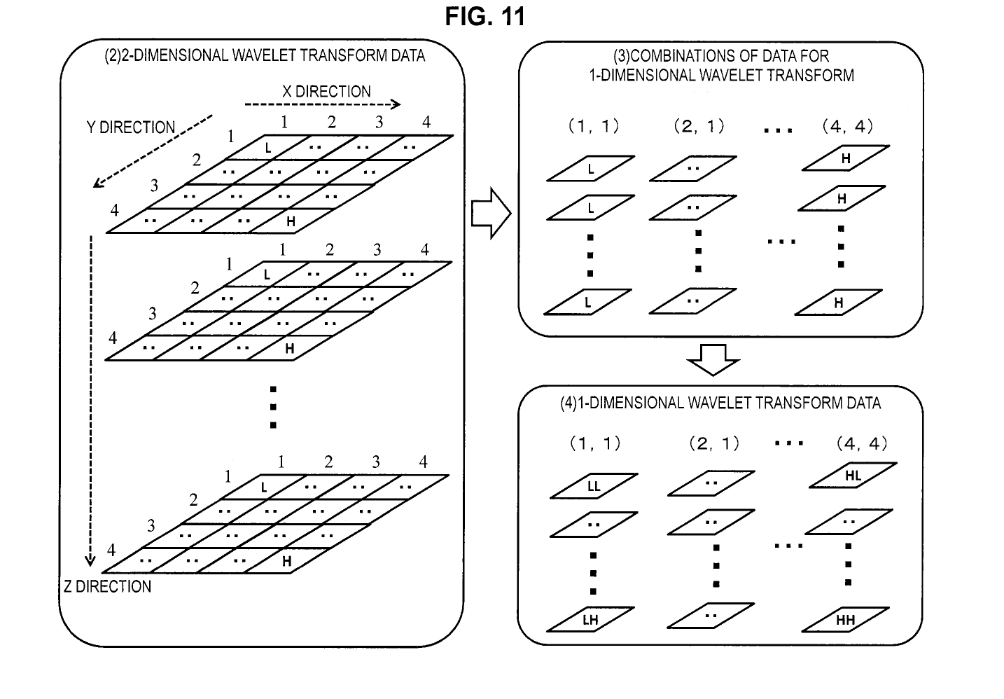

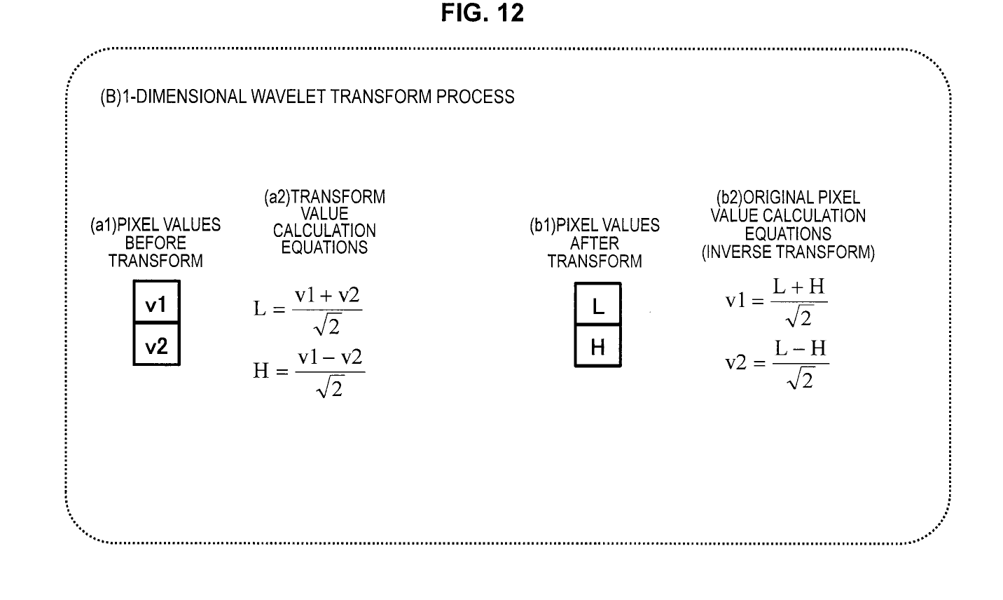

Next, the 1-dimensional wavelet transform process performed in step S12 of the flow illustrated in FIG. 8 will be described with reference to FIGS. 11 and 12.

FIG. 11(2) illustrates data which is the same as the data illustrated in FIG. 9(2) and is 2-dimensional wavelet transform data generated through the 2-dimensional wavelet transform in step S11 of the flow of FIG. 8. FIG. 11(3) illustrates combinations of data for the 1-dimensional wavelet transform. FIG. 11(4) illustrates 1-dimensional wavelet transform data.

In step S12, the 1-dimensional wavelet transform is performed on the pixel row in which the pixels at the same XY position of the 2-dimensional wavelet transform data in the units of the highpass signal images corresponding to the local regions generated in S11, that is, the 2-dimensional wavelet transform data in the units of the highpass signal images corresponding to the local regions illustrated in FIG. 11(2), are arranged in the Z-axis direction.

The pixel row to be subjected to the 1-dimensional wavelet transform process is each data illustrated in FIG. 11(3). That is, when an image corresponding to each local region is an image with 4×4 pixels, 16 1-dimensional pixel rows of (x, y)=(1, 1) to (4, 4) are generated and the 1-dimensional wavelet transform is individually performed on each of the 16 1-dimensional pixel rows.

The data generated through the 1-dimensional wavelet transform is 1-dimensional wavelet transform data illustrated in FIG. 11(4).

In the example, a total of 16 pieces of 1-dimensional wavelet transform data of (x, y)=(1, 1) to (4, 4) are generated.

As described above, the wavelet transform process is a process of separating frequency components included in an image and separating the image in signals in predetermined units of the frequency components.

In the 1-dimensional wavelet transform, this process is performed on a 1-dimensional image. FIG. 12 is a diagram illustrating a processing example of the 1-dimensional Haar wavelet transform process as an example of the 2-dimensional wavelet transform process.

For example, as illustrated in FIG. 12(a1), there are 2 pixel regions. When the pixel values of the pixels are v1 and v2, values L and H illustrated in FIG. 12(b1) are set as values after the transform through the 1-dimensional wavelet transform process. Each of the values is referred to as a development coefficient.

As illustrated in FIG. 12(a2), the values (development coefficients) L and H after the transform are calculated using the following equations based on the pixel values v1 and v2 before the transform:

L=(v1+v2)/√2, and

H=(v1−v2)/√2.

In the example illustrated in FIG. 12, the process for 2 pieces of pixel data has been described. However, when the process is performed on an image with a plurality of pixels such as 4 pixels, for example, a 2-level process is performed in such a manner that the transform according to the foregoing calculation equations is performed in units of 2 pixels as a 1st level process, and then the process according to the foregoing calculation equations is performed on 1st level transform data again as a 2nd level process. In this way, the same transform process may be configured to be performed repeatedly.

The data in which the signals L and H in the units of the frequency components are set is assumed to be 2-dimensional wavelet transform data. The data illustrated in FIG. 12(b1) is an example of the 2-dimensional wavelet transform data.

Equations used to calculate the original v1 and v2 from the signals of the development coefficients L to H which are elements of the 2-dimensional wavelet transform data are the following equations, as illustrated in FIG. 12(b2):

v1=(L+H)/√2, and

v2=(L−H)/√2.

The process according to the equations corresponds to the 1-dimensional wavelet inverse-transform.

In step S14 illustrated in FIG. 8, the 1-dimensional wavelet inverse-transform (1-dimensional Haar wavelet transform) is performed according to the foregoing equations.

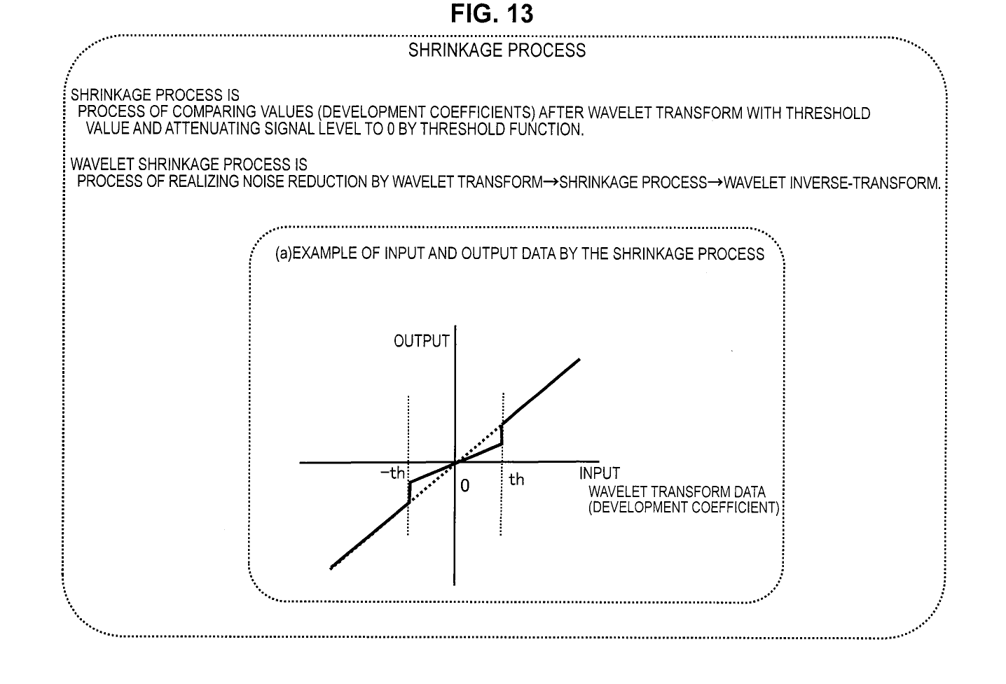

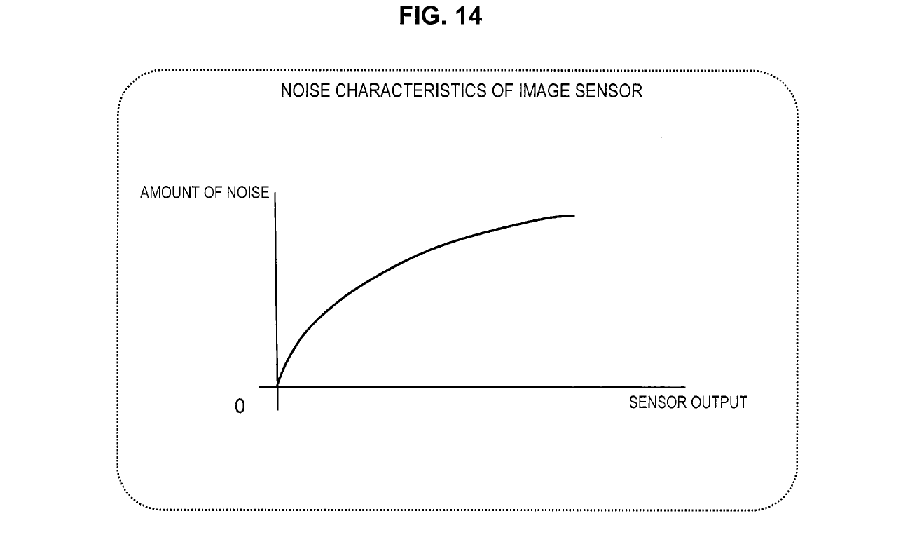

Next, the shrinkage process performed in step S13 of the flow illustrated in FIG. 8 will be described with reference to FIGS. 13 and 14.

The shrinkage process performed in this embodiment is a process of comparing the values after the wavelet transform, that is, the development coefficients such as LL to HH, which are the data after the wavelet transform described with reference to FIGS. 9 to 12, with a predetermined threshold value (th) and attenuating a signal with a value equal to or less than the threshold value (th) to 0.

A series of processes of first performing a wavelet transform on image signals, performing the shrinkage process on the development coefficients which are signals after the transform, and then performing a wavelet inverse-transform is referred to as a wavelet shrinkage process.

In FIG. 13, (a) illustrates a graph illustrating an example of input and output data by the shrinkage process.

The horizontal axis represents an input value and the vertical axis represents an output value. Here, both of the input and output values are wavelet transform data, that is, development coefficients.

When the absolute value of the input value is less than the threshold value (th), the absolute value is changed to be close to 0. When the absolute value of the input value is equal to or greater than the threshold value (th), the absolute value is not changed.

A signal with the absolute value of the input value less than the threshold value (th) is a signal that has a minute amplitude, that is, a signal that includes many noise components. By selectively reducing the signal level of this portion, effective noise reduction is realized.

The threshold value (th) is determined according to noise characteristics of the image sensor and is stored in advance in a memory included in the image processing device.

FIG. 14 is a graph illustrating an example of a correspondence relation between a sensor output of the image sensor and an amount of noise.

The larger the sensor output is, the larger the amount of noise is. However, a ratio of the amount of noise occupying the sensor output gradually decreases as the sensor output increases.

The noise characteristics are characteristics unique to the image sensor and are data determined in a manufacturing state of the image sensor.

When the image sensor is manufactured, the noise characteristics of an individual image sensor are measured, and a threshold value (th) illustrated in FIG. 13 is determined based on the measured noise characteristics and is stored in a memory included in the imaging device. The threshold value (th) may be set so as to be adjusted by the user.

In step S13 of the flow illustrated in FIG. 8, the shrinkage process is performed on each piece of the 1-dimensional wavelet transform data generated in step S12, that is, the plurality of pieces of 1-dimensional wavelet transform data illustrated in FIG. 11(4).

Through this process, at least some of the signal values (development coefficients) set in the plurality of pieces of 1-dimensional wavelet transform data illustrated in FIG. 11(4) are changed.

After the shrinkage process, the 1-dimensional wavelet inverse-transform process is performed in step S14 of the flowchart illustrated in FIG. 8.

The 1-dimensional wavelet inverse-transform process is a process of calculating v1 and v2 from the development coefficients L and H according to the equations illustrated in FIG. 12(b2), that is, the following equations, as described above with reference to FIG. 12:

v1=(L+H)/√2, and

v2=(L−H)/√2.

The values calculated through the 1-dimensional wavelet inverse-transform process performed in step S14 of FIG. 8 correspond to a process of returning the 1-dimensional transform data illustrated in FIG. 11(4) to the data illustrated in FIG. 11(3), so that the 2-dimensional wavelet transform data is calculated.

In step S15 of the flow illustrated in FIG. 8, the 2-dimensional wavelet inverse-transform process is performed.

The 2-dimensional wavelet inverse-transform process is performed on reconstruction 2-dimensional data so that the 2-dimensional data which corresponds to the XY plane corresponding to each local region from the 1-dimensional wavelet inverse-transform data generated in the process of step S14 is reconstructed.

That is, the 2-dimensional data corresponding to each local region which is the same as the data illustrated in FIG. 9(2) is reconstructed, the 2-dimensional wavelet inverse-transform process is performed on the 2-dimensional data, and the noise-removed highpass signal image corresponding to the local region having the configuration illustrated in FIG. 9(1) is generated.

The 2-dimensional wavelet inverse-transform process in step S15 may be performed only on the highpass signal image corresponding to the local region of interest set as the noise reduction processing target. The noise-reduced highpass signal image corresponding to the local region of interest is generated through this process.

As described above with reference to FIG. 10, the 2-dimensional wavelet inverse-transform process is a process of calculating v1 to v4 from the development coefficients LL to HH according to the equations illustrated in FIG. 10(b2), that is, the following equations:

v1=(LL+HL+LH+HH)/2,

v2=(LL−HL+LH−HH)/2,

v3=(LL+HL−LH−HH)/2, and

v4=(LL−HL+LH−HH)/2.

As described above, the example illustrated in FIG. 10 is the process on the 2×2 pieces of pixel data, that is, 4 pieces of pixel data. For example, when the process is performed on an image with a plurality of pixels such as 4×4 pixels, a process of a plurality of levels, that is, multiple-stage processes, may also be configured to be performed repeatedly in the wavelet inverse-transform process, as in the wavelet transform process.

However, it is necessary to perform the 2-dimensional wavelet inverse-transform process of step S15 illustrated in FIG. 8 as an inverse process to the 2-dimensional wavelet transform process of step S11. Thus, it is necessary to perform an inverse transform process corresponding to a processing form of the 2-dimensional wavelet transform process of step S11.

Likewise, it is also necessary to perform the 1-dimensional wavelet inverse-transform process of step S14 as an inverse process to the 1-dimensional wavelet transform process of step S12. Thus, it is necessary to perform an inverse transform process corresponding to a processing form of the 1-dimensional wavelet transform process of step S12.

Thus, the highpass noise reduction unit 104 illustrated in FIG. 4 generates the highpass signal images in which the noise is reduced by sequentially performing the processes of step S11 to step S15 according to the flowchart illustrated in FIG. 8, that is, the following processes:

(S11) the 2-dimensional wavelet transform process on the highpass signal images in the units of the local regions,

(S12) the 1-dimensional wavelet transform process,

(S13) the shrinkage process,

(S14) the 1-dimensional wavelet inverse-transform process, and

(S15) the 2-dimensional wavelet inverse-transform process.

The highpass noise reduction unit 104 illustrated in FIG. 4 generates the highpass signal images in which the noise is reduced by performing these processes.

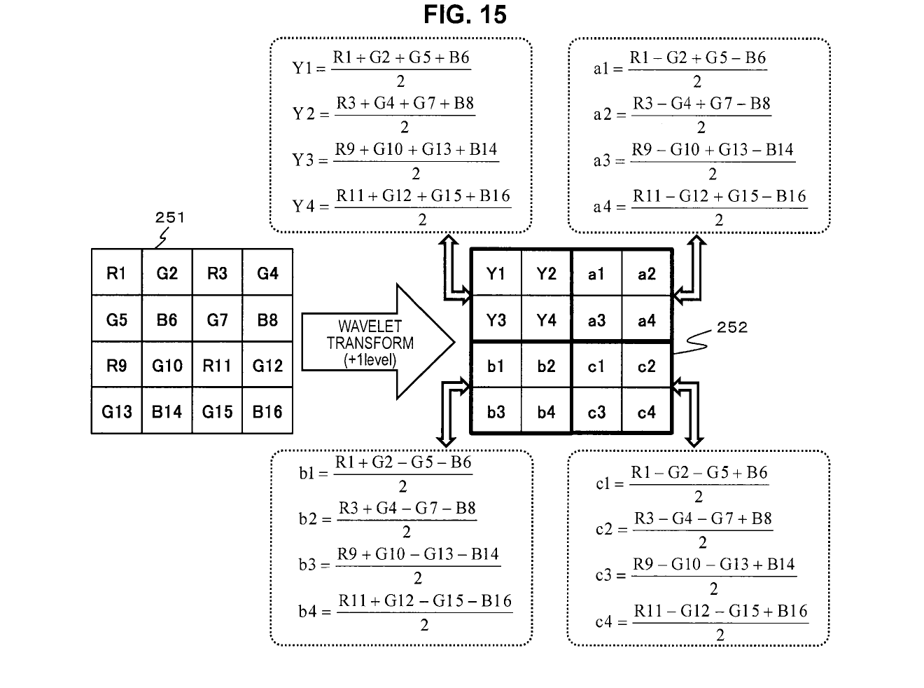

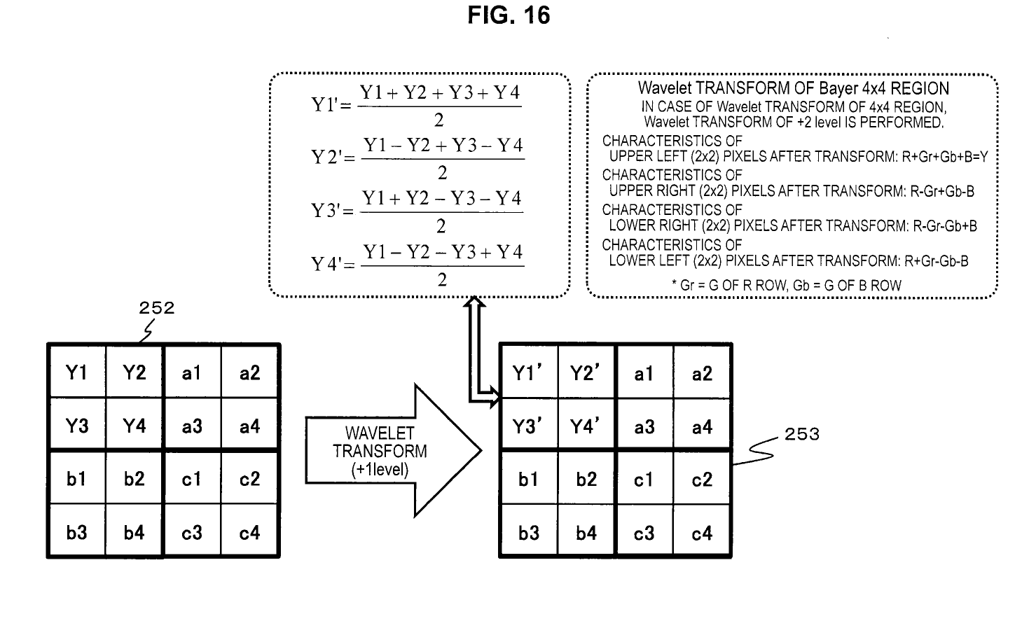

One of the characteristics of the noise reduction process according to the flow illustrated in FIG. 8 will be described with reference to FIGS. 15 and 16.

In step S11 of the flow illustrated in FIG. 8, the 2-dimensional wavelet transform process is performed on each of the highpass signal images corresponding to the local regions.

The wavelet transform data is separated into a luminance signal (Y) and other data such as a color difference signal by performing the 2-dimensional wavelet transform process on a RAW image with an RGB Bayer array, and thus the subsequent process can be performed.

FIGS. 15 and 16 are diagrams illustrating a specific processing form of the 2-dimensional wavelet transform on the RAW image with the Bayer array.

FIG. 15 illustrates a processing example in which 1st level 2-dimensional wavelet transform data 252 is generated by performing a 2-dimensional wavelet transform of a 1st level on highpass signal image data 251 with 4×4 pixels to be processed.

FIG. 16 illustrates a processing example in which 2nd level 2-dimensional wavelet transform data 253 is generated by performing a 2-dimensional wavelet transform process of the 2nd level on the 1st level wavelet transform data 252 generated through the process of FIG. 15.

First, the process illustrated in FIG. 15 will be described.

FIG. 15 illustrates a processing example in which the 1st level 2-dimensional wavelet transform data 252 is generated by performing a 2-dimensional Haar wavelet transform of the 1st level on the highpass signal image data 251 with 4×4 pixels to be processed.

The highpass signal image data 251 with 4×4 pixels is highpass signal image data generated based on the RAW image with the Bayer array including RGB pixels.

The highpass signal image data 251 with 4×4 pixels includes RGB pixel signals from R1 to B16, as illustrated in the drawing. In the processing example, R1 to B16 are all highpass signals.

When the 2-dimensional wavelet transform of the 1st level is performed on the highpass signal image data 251, the 1st level 2-dimensional wavelet transform data 252 including signals (development coefficients) Y1 to c4 illustrated in FIG. 16 is generated.

The constituent signals (development coefficients) Y1 to c4 of the 1st level 2-dimensional wavelet transform data 252 are calculated through a calculation process according to the following transform equations for the constituent signals R1 to B16 of the highpass signal image data.

Y1=(R1+G2+G5+B6)/2

Y2=(R3+G4+G7+B8)/2

Y3=(R9+G10+G13+B14)/2

Y4=(R11+G12+G15+B16)/2

a1=(R1−G2+G5−B6)/2

a2=(R3−G4+G7−B8)/2

a3=(R9−G10+G13−B14)/2

a4=(R11−G12+G15−B16)/2

b1=(R1+G2−G5−B6)/2

b2=(R3+G4−G7−B8)/2

b3=(R9+G10−G13−B14)/2

b4=(R11+G12−G15−B16)/2

c1=(R1−G2−G5+B6)/2

c2=(R3−G4−G7+B8)/2

c3=(R9−G10−G13+B14)/2

c4=(R11−G12−G15+B16)/2

Of the foregoing transform equations, the following 4 transform equations all correspond to the calculation equations of the luminance signal (Y):

Y1=(R1+G2+G5+B6)/2,

Y2=(R3+G4+G7+B8)/2,

Y3=(R9+G10+G13+B14)/2, and

Y4=(R11+G12+G15+B16)/2

As an equation used to calculate the luminance (Y) signal from the RGB signals, the following equation is known:

Y=R+2G+B.

Data corresponding to the luminance signals (Y) is set as the transform values (development coefficients) in all of the pixels of the upper left quarter among the constituent pixels of the 1st level 2-dimensional wavelet transform data 252 calculated according to the 2-dimensional wavelet transform illustrated in FIG. 15.

Further, the values of a1 to a4, b1 to b4, and c1 to c4 are set in the remaining ¾ of the pixels excluding the pixels of the upper left quarter among the constituent pixels of the 1st level 2-dimensional wavelet transform data 252. However, the set values are values corresponding to the color difference signals.

FIG. 16 illustrates a processing example in which the 2-dimensional Haar wavelet transform is further processed on the 1st level 2-dimensional wavelet transform data 252.

The 2-dimensional wavelet transform of the 2nd level is performed as a transform process on the pixels of the upper left quarter of the 1st level 2-dimensional wavelet transform data 252. As a result, the 2nd level wavelet transform data 253 including signal values (development coefficients) Y1′ to c4 illustrated in the drawing is generated.

The values of Y1′ to Y4′ are calculated according to the following transform equations:

Y1′=(Y1+Y2+Y3+Y4)/2,

Y2′=(Y1−Y2+Y3−Y4)/2,

Y3′=(Y1+Y2−Y3−Y4)/2, and

Y4′=(Y1−Y2−Y3+Y4)/2.

Here, a1 to c4 are maintained as the constituent data of the 1st level 2-dimensional wavelet transform data 252

Even when the 2-dimensional wavelet transform process of the 2nd level is performed, all of the signals of the constituent pixels of the upper left quarter of the constituent data of the 2nd level wavelet transform data 253 are signals generated using the luminance signals (Y).

Thus, when the 2-dimensional wavelet transform is performed on the RAW image with the Bayer array, all the constituent data of the pixels of the upper left quarter among the signal values (development coefficients) generated through the transform process is signal values configured by the luminance signals.

In FIGS. 15 and 16, only the examples of the 2-dimensional wavelet transform process of the 1st and 2nd levels are illustrated. However, even when 2-dimensional wavelet transform after a 3rd level is performed, all the constituent data of the pixels of the upper left quarter among the signal values (development coefficients) generated through the transform process is signal values configured by the luminance signals.

In the configuration of this processing example, the wavelet transform data is separated into the luminance signal (Y) and another signal corresponding to the color difference signal in the 2-dimensional wavelet transform process, and the shrinkage process is performed on each of the separated signals as the noise reduction process. Therefore, both of luminance and a color difference are balanced and the noise can be reduced. The reduction in the noise of not only luminance but also color can be performed with high accuracy.

[2-6-2. (2nd Processing Example) Noise Reduction Process by 2-Dimensional Wavelet Transform+ε Filter (Epsilon Filter)]

Next, a noise reduction process using the 2-dimensional wavelet transform+an ε filter (epsilon filter) will be described as a 2nd processing example.

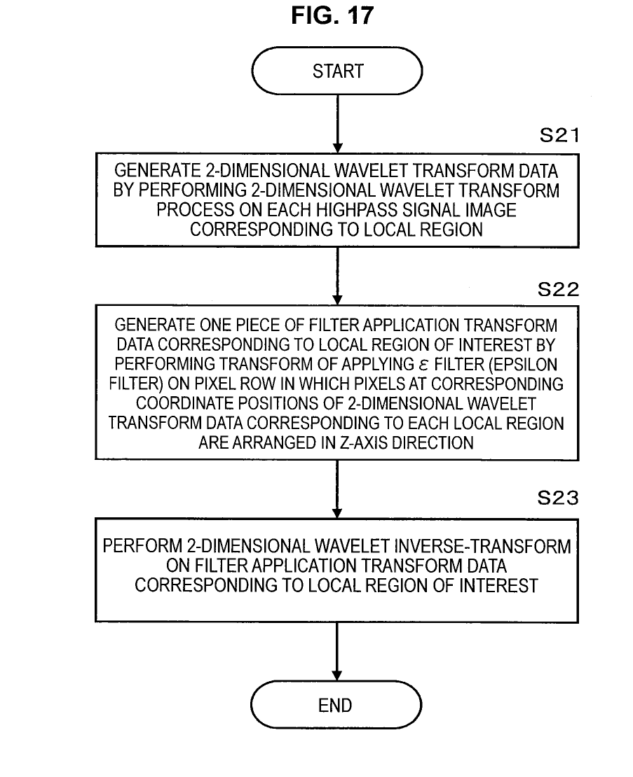

A processing sequence of the 2nd processing example will be described with reference to the flowchart illustrated in FIG. 17. In the 2nd processing example, noise reduction is realized by performing a processing order illustrated in FIG. 17, that is, step S21 to step S23.

First, after a series of processes is described simply according to the flow, the details of the processes will be described.

(S21) First, 2-dimensional wavelet transform data in the units of the highpass signal images corresponding to the local regions is generated by performing a 2-dimensional wavelet transform on a highpass signal image corresponding to each local region of the 3-dimensional data illustrated in FIG. 7, that is, each XY plane.

(S22) Next, a transform process of applying the ε filter (epsilon filter) is performed on a pixel row in which pixels at the same XY position of the 2-dimensional wavelet transform data in the units of the highpass signal images corresponding to the local regions generated in S21 are arranged in the Z-axis direction.

Through this process, one piece of filter application transform data corresponding to the local region of interest is generated.

(S23) A 2-dimensional wavelet inverse-transform is performed on the filter application transform data corresponding to the local region of interest generated in step S22.

The noise contained in the highpass signals is reduced by performing the series of processes of step S21 to step S23.

Hereinafter, the details of the processes of the steps will be described.

The process of step S21 is the same as the process of step S11 of the flow of the above-described example (1st processing example) illustrated in FIG. 8. That is, in step S21, the 2-dimensional wavelet transform is performed on the 3-dimensional data described with reference to FIG. 7, that is, the highpass signal images corresponding to the local regions, which are arranged as the XY plane in the Z direction by setting the highpass signal image corresponding to each local region, for each highpass signal image of each local region.

The 2-dimensional wavelet transform process is the process described above with reference to FIG. 9 and FIG. 10 and is a process of separating a high-frequency component from a low-frequency component contained in an image and separating the image into signals in predetermined units of the frequency components.

Specifically, as illustrated in FIG. 10(a2), the values LL to HH after the transform are calculated using the following equations based on the pixel values v1 to v4 before the transform:

LL=(v1+v2+v3+v4)/2,

HL=(v1−v2+v3−v4)/2,

LH=(v1+v2−v3−v4)/2, and

HH=(v1−v2−v3+v4)/2.

As described above with reference to FIGS. 15 and 16, the highpass signal image corresponding to each local region can be separated into a luminance (Y) component and a color difference component through the 2-dimensional wavelet transform process.

Next, the ε filter (epsilon filter) application process performed in step S22 of the flow illustrated in FIG. 17 will be described.

In step S22, the transform process of applying the ε filter (epsilon filter) is performed on the pixel row in which pixels at the same XY position of the 2-dimensional wavelet transform data in the units of the highpass signal images corresponding to the local regions generated in S21 are arranged in the Z-axis direction.

Through this process, one piece of filter application transform data corresponding to the local region of interest is generated.

The ε filter (epsilon filter) is a filter used to calculate a signal value (ε(V)) of a pixel of interest to be processed according to the following (Equation 5).

ε(V)=avg(V)

V={v∥vᵢ−vref|<th} (Equation 5)

In the foregoing equation, vref indicates a pixel value of the local region of interest, vi indicates a pixel value of each local region at the pixel position corresponding to vref, and th indicates a predetermined threshold value.

V={v∥vi−ref|<th} is an equation used to select the pixel value (vi) of each local region (the local region of interest and the similar local regions) in which a difference from the pixel value (vref) of the local region of interest is less than the threshold value (th).

Specifically, the foregoing (Equation 5) is an equation used to set an average value avg(V) of the pixel values (vi) of the similar local regions in which the difference from the pixel value (vref) of the local region of interest is less than the threshold value (th) as a pixel value ε(V) of the pixels of the local region of interest.

That is, according to the foregoing (Equation 5), only the following pixels are selected and the average value of the selected pixels is set as a new pixel value of the pixels of the local region of interest:

the pixels of the local region of interest set as the noise reduction processing target, and

the pixels of the similar local region in which a difference from the pixel values of the pixels of the local region of interest is small.

Here, the “pixel value” in the description of the foregoing (Equation 5) is data after the 2-dimensional wavelet transform and corresponds to the development coefficient.

The ε filter (epsilon filter) application process performed in the (2nd processing example) is a process that is performed instead of the series of processes, that is, the 1-dimensional wavelet transform process of step S12 to step S14 of the flow of FIG. 8 in the above-described (1st processing example), the shrinkage process, and the 1-dimensional wavelet inverse-transform process.

The ε filter (epsilon filter) application process is a light process compared to the processes of step S12 to step S14 of the (1st processing example) and has the advantages that this process can be performed easily even in a device with a comparatively low processing performance and a processing time is shortened.

Finally, in step S23 of the flow illustrated in FIG. 17, the 2-dimensional wavelet inverse-transform process is performed on one piece of filter application conversion data corresponding to the local region of interest generated in step S22.

As described above with reference to FIG. 10, the 2-dimensional wavelet inverse-transform process is a process used to calculate v1 to v4 from the development coefficients LL to HH according to the equations illustrated in FIG. 10(b2), that is, the following equations:

v1=(LL+HL+LH+HH)/2,

v2=(LL−HL+LH−HH)/2,

v3=(LL+HL−LH−HH)/2, and

v4=(LL−HL+LH−HH)/2.

As described above, the example illustrated in FIG. 10 is the process on the 2×2 pieces of pixel data, that is, 4 pieces of pixel data. For example, when the process is performed on an image with a plurality of pixels such as 4×4 pixels, a process of a plurality of levels, that is, multiple-stage processes, may also be configured to be performed repeatedly in the wavelet inverse-transform process, as in the wavelet transform process.

However, it is necessary to perform the 2-dimensional wavelet inverse-transform process of step S23 illustrated in FIG. 17 as an inverse process to the 2-dimensional wavelet transform process of step S21. Thus, it is necessary to perform an inverse transform process corresponding to a processing form of the 2-dimensional wavelet transform process of step S21.

In the configuration to which the (2nd processing example) is applied, the highpass noise reduction unit 104 illustrated in FIG. 4 generates the highpass signal images in which the noise is reduced by sequentially performing the processes of step S21 to step S23 according to the flowchart illustrated in FIG. 17, that is, the following processes:

(S21) the 2-dimensional wavelet transform process on the highpass signal images in the units of the local regions,

(S22) the transform process of applying the ε filter (epsilon filter), and

(S23) the 2-dimensional wavelet inverse-transform process.

The highpass noise reduction unit 104 illustrated in FIG. 4 generates the highpass signal images in which the noise is reduced by performing these processes.

Even in the configuration of the 2nd processing example, the wavelet transform data is separated into the luminance signal (Y) and another signal corresponding to the color difference signal in the 2-dimensional wavelet transform process, as in the above-described 1st processing example, and the process of applying the ε filter is performed on each of the separated signals as the noise reduction process. Therefore, both of luminance and a color difference are balanced and the noise can be reduced. The reduction in the noise of not only luminance but also color can be performed with high accuracy.

[2-6-3. (3rd Processing Example) Noise Reduction Process by ε Filter (Epsilon Filter) of Z Direction]

Next, a noise reduction process using an ε filter (epsilon filter) of the Z direction will be described as a 3rd processing example.

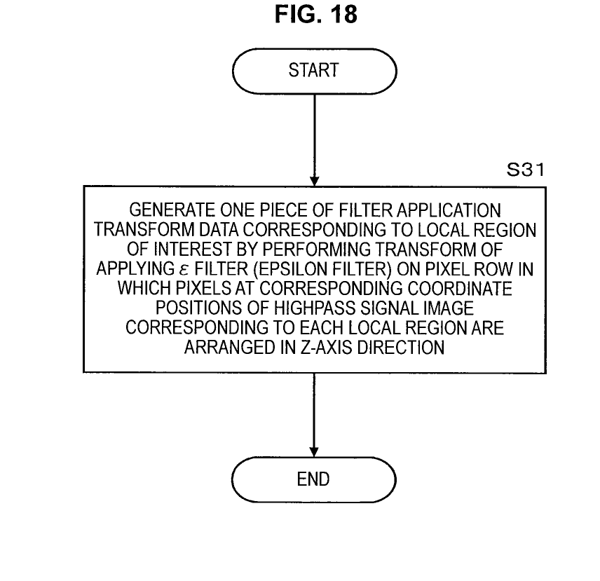

A processing sequence of the 3rd processing example will be described with reference to the flowchart illustrated in FIG. 18. In the 3rd processing example, noise reduction is realized by performing step S31 illustrated in FIG. 18.

Step S31 is the following process.

(S31) A transform process of applying the ε filter (epsilon filter) is performed on a pixel row in which pixels at the same XY position of the highpass signal image corresponding to each local region of the 3-dimensional data illustrated in FIG. 7 are arranged in the Z-axis direction.

Through this process, one piece of filter application transform data corresponding to the local region of interest is generated.

One piece of filter application transform data corresponding to the local region of interest is assumed to be a highpass signal image after the noise reduction.

The (3rd processing example) is a configuration example in which only the process of step S22 of the (2nd processing example) described above with reference to the flowchart of FIG. 17 is performed and corresponds to a configuration example in which the 2-dimensional wavelet transform of step S21 and the 2-dimensional wavelet inverse-transform of step S23 are omitted.

The 3rd processing example can be performed as a very simple process compared to the above-described (1st processing example) and (2nd processing example) and has the advantages that a calculation load is small and a processing speed is fast.

[2-7. Process of Lowpass Noise Reduction Unit]

Next, the process of the lowpass noise reduction unit 105 of the RAW noise reduction unit 31 illustrated in FIG. 4 will be described.

The lowpass noise reduction unit 105 performs a process of reducing noise contained in a lowpass component of a local region of interest using lowpass signal image data of the local region of interest and the similar local regions input from the band separation unit 103.

A lowpass signal image corresponding to one local region of interest and n lowpass signal images corresponding to n similar local regions, that is, n+1 lowpass signal images are input from the band separation unit 103.

These signals are data that has the structure described above with reference to FIG. 7 as the structure of data input to the highpass noise reduction unit 104.

FIG. 7 illustrates the highpass signal images of one local region of interest and n similar local regions. These highpass signal images are input to the highpass noise reduction unit 104.

The lowpass signal images of one local region of interest and n similar local regions having the same structure as the structure illustrated in FIG. 7 are input to the lowpass noise reduction unit 105.

The lowpass noise reduction unit 105 reduces noise using the n+1 images.

As described above, the band separation unit 103 calculates each pixel value (A^{low}_{x, y}) of the lowpass signal image data 115 of each of the local region of interest and the similar local regions and each piece of local region image data included in the similar local region group data 113 according to the above-described (Equation 3).

As described above, an average (DC component) of each of RGB in the local region is calculated as a lowpass signal value (A^{low}_{x, y}) in (Equation 3). In the case of the Bayer array, since there are three colors RGB, 3 lowpass signal values are calculated as lowpass signal values of RGB in units of local regions according to the foregoing (Equation 3).

The lowpass noise reduction unit 105 inputs the signal values of RGB corresponding to, for example, the one local region of interest and the n similar local regions which are the same as those illustrated in FIG. 7 to perform the process.

That is, the noise included in the lowpass signal image corresponding to the local region of interest is reduced using the following signals:

n+1 R signals,

n+1 G signals, and

n+1 B signals.

Various methods can be applied as the noise reduction process performed by the lowpass noise reduction unit 105. Hereinafter, a plurality of examples of the noise reduction process applicable to the lowpass noise reduction unit 105 will be described. The following processing examples will be described in order:

(1st processing example) a noise reduction process of performing 1-dimensional wavelet shrinkage on each piece of the 1-dimensional data including average (DC) signal of same color (R, G, or B) in units of the local regions in each of the local region of interest and a plurality similar local regions, and

(2nd processing example) a noise reduction process of applying an ε filter (epsilon filter) to each piece of the 1-dimensional data including average (DC) signal of same color (R, G, or B) in units of the local regions in the local region of interest and a plurality similar local regions.

[2-7-1. (1st Processing Example) Noise Reduction Process by 1-Dimensional Wavelet Shrinkage]

First, the noise reduction process by 1-dimensional wavelet shrinkage will be described as the 1st processing example.

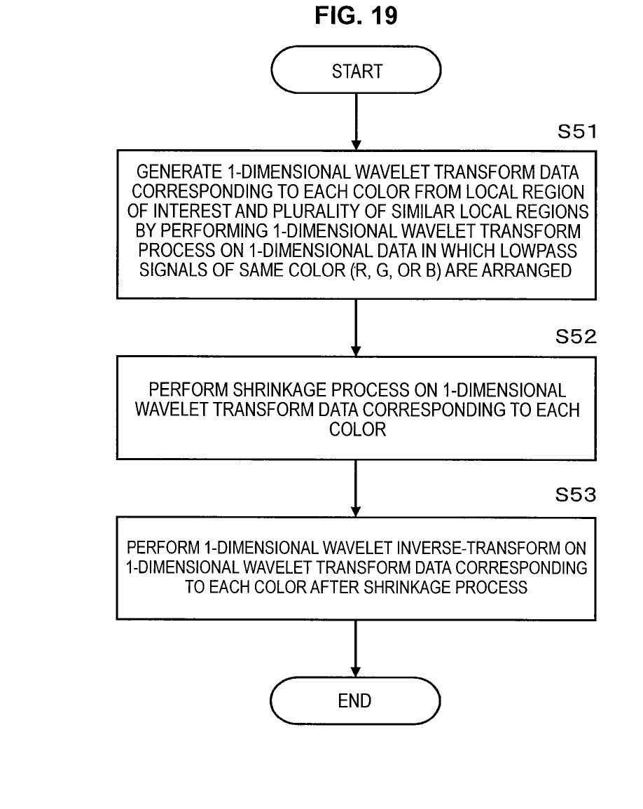

A processing sequence of the 1st processing example will be described with reference to the flowchart illustrated in FIG. 19. In the 1st processing example, noise reduction is realized by performing a processing order illustrated in FIG. 19, that is, step S51 to step S53.

First, after a series of processes is described simply according to the flow, the details of the processes will be described.

(S51) First, 1-dimensional wavelet transform data corresponding to each color is generated from the local region of interest and the plurality of similar local regions by performing the 1-dimensional wavelet transform process on 1-dimensional data in which lowpass signals of the same color (R, G, or B) are arranged.

(S52) Next, a shrinkage process is performed on each piece of the 1-dimensional wavelet transform data corresponding to each color generated in step S51.

(S53) A 1-dimensional wavelet inverse-transform is performed on the 1-dimensional wavelet transform data after the shrinkage process performed in step S52.

Noise contained in the lowpass signal is reduced by performing the series of processes of steps S51 to step S53.

Hereinafter, the details of the processes of the steps will be described.

In step S51, first, the 1-dimensional wavelet transform data corresponding to each color is generated from the local region of interest and the plurality of similar local regions by performing the 1-dimensional wavelet transform process on the 1-dimensional data in which the lowpass signals of the same color (R, G, or B) are arranged.

The 1-dimensional data to be processed is a lowpass signal row of the same color (R, G, or B) signal corresponding to each local region of one local region of interest and n similar local regions which are the same as those illustrated in FIG. 7.

That is, the 1-dimensional wavelet transform is performed on each of the following pieces of 1-dimensional data:

1-dimensional data including n+1 R signals,

1-dimensional data including n+1 G signals, and

1-dimensional data including n+1 B signals.

The 1-dimensional wavelet transform is the same process as the process performed by the highpass noise reduction unit 104 and described above with reference to FIG. 11 and FIG. 12.

As illustrated in FIG. 12(a2), values L and H after transform are calculated based on pixel values v1 and v2 before transform using the following equations:

L=(v1+v2)/√2, and

H=(v1−v2)/√2.

In the example illustrated in FIG. 12, the process for 2 pieces of pixel data has been described. However, when the process is performed on an image with a plurality of pixels such as 4 pixels, for example, a 2-level process is performed in such a manner that the transform according to the foregoing calculation equations is performed in units of 2 pixels as a 1st level process, and then the process according to the foregoing calculation equations is performed on 1st level transform data again as a 2nd level process. In this way, the same transform process may be configured to be performed repeatedly.

Next, in step S52, the shrinkage process is performed on each piece of the 1-dimensional wavelet transform data corresponding to each color generated in step S51.

The shrinkage process is the same process as the process performed by the highpass noise reduction unit 104 and described above with reference to FIGS. 13 and 14.

As described above, in FIG. 13, (a) illustrates a graph illustrating an example of input and output data by the shrinkage process. The horizontal axis represents an input value, that is, a development coefficient which is a signal after the wavelet transform

The vertical axis represents an output value of the development coefficient after the shrinkage process.

When the absolute value of the input value is less than the threshold value (th), the absolute value is changed to be close to 0. When the absolute value of the input value is equal to or greater than the threshold value (th), the absolute value is not changed.

A signal with the absolute value of the input value less than the threshold value (th) is a signal that has a minute amplitude, that is, a signal that includes many noise components. By selectively reducing the signal level of this portion, effective noise reduction is realized. The threshold value (th) is determined according to noise characteristics of the image sensor and is stored in advance in a memory included in the image processing device.

In step S52 of the flow illustrated in FIG. 19, the shrinkage process is performed on each piece of the 1-dimensional wavelet transform data corresponding to each color generated in step S51.

Through this process, at least some of the signal values (development coefficients) set in the 1-dimensional wavelet transform data corresponding to each color are changed.

After the shrinkage process, the 1-dimensional wavelet inverse-transform process is performed in step S53 of the flowchart illustrated in FIG. 19.

The 1-dimensional wavelet inverse-transform process is a process of calculating v1 and v2 from the development coefficients L and H according to the equations illustrated in FIG. 12(b2), that is, the following equations, as described above with reference to FIG. 12:

v1=(L+H)/√2, and

v2=(L−H)/√2.

Through this process, a 1-dimensional data row in which the noise is reduced and which corresponds to each color of RGB is generated.

The lowpass noise reduction unit 105 illustrated in FIG. 4 outputs each signal of RGB of the local region of interest that forms the 1-dimensional data row corresponding to RGB as a lowpass signal after the noise reduction.

Thus, the lowpass noise reduction unit 105 illustrated in FIG. 4 generates the lowpass signal image in which noise is reduced by sequentially performing the processes of step S51 to step S53 of the flowchart illustrated in FIG. 19, that is, the following processes:

(S51) the 1-dimensional wavelet transform process on lowpass signal row of the colors of RGB corresponding to each local region,

(S52) the shrinkage process, and

(S53) the 1-dimensional wavelet inverse-transform process.

The lowpass noise reduction unit 105 illustrated in FIG. 4 generates the lowpass signal image in which the noise is reduced by performing these processes.

[2-7-2. (2nd Processing Example) Noise Reduction Process of Applying ε Filter (Epsilon Filter) to Each Piece of 1-Dimensional Data Including Average (DC) Signal of Same Color (R, G, or B) in Units of Local Regions]

Next, a noise reduction process of applying an ε filter (epsilon filter) to each piece of 1-dimensional data including an average (DC) signal of the same color (R, or B) in units of the local regions in a local region of interest and a plurality of similar local regions will be described as the 2nd processing example.

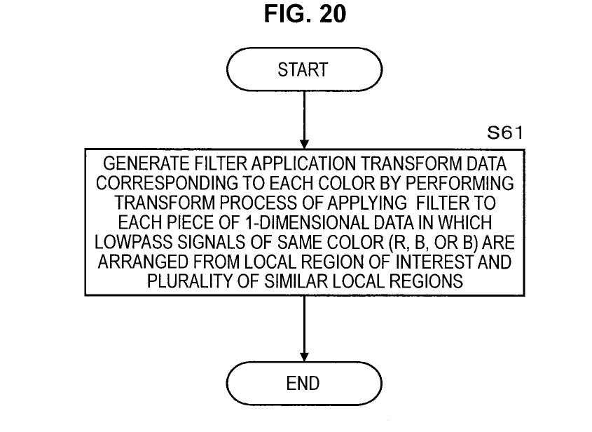

A processing sequence of the 2nd processing example will be described with reference to the flowchart illustrated in FIG. 20. In the 2nd processing example, noise reduction is realized by performing step S61 illustrated in FIG. 20.

Step S61 is the following process.

(S61) 1-dimensional data in which lowpass signals of the same color (R, G, or B) are arranged is generated from each local region of the 3-dimensional data illustrated in FIG. 7, that is, the local region of interest and the plurality of similar local regions, and filter application transform data corresponding to each color is generated by performing a transform process of applying the ε filter (epsilon filter) to each of the 1-dimensional data.

Through this process, one piece of filter application transform data corresponding to the local region of interest is generated.

On piece of filter application transform data corresponding to the local region of interest is assumed to be a lowpass signal image after the noise reduction.

The ε filter (epsilon filter) is the same filter as the filter applied in step S22 of the flow of FIG. 17 in the (2nd processing example) of the highpass noise reduction unit 104 described above.

That is, the ε filter is a filter that performs a pixel value transform according to the foregoing (Equation 5).

Specifically, as described above with reference to (Equation 5), an average value avg(V) of the pixel values (vi) of the similar local regions in which a difference from the pixel value (vref) of the local region of interest is less than the threshold value (th) is set as a pixel value ε(V) of the pixels of the local region of interest.

The ε filter (epsilon filter) application process performed in the (2nd processing example) is a process that is performed instead of the series of processes, that is, the 1-dimensional wavelet transform process, the shrinkage process, and the 1-dimensional wavelet inverse-transform process. The ε filter (epsilon filter) application process is a light process compared to the series of processes and has the advantages that this process can be performed easily even in a device with a comparatively low processing performance and a processing time is shortened.

### 2-8. Process of Band Combining Unit

Next, a process performed by the band combining unit 106 of the RAW noise reduction unit 31 illustrated in FIG. 4 will be described.

The band combining unit 106 inputs each of the following signals:

the highpass signal after the noise reduction corresponding to the local region of interest output from the highpass noise reduction unit 104, and

the lowpass signal after the noise reduction corresponding to the local region of interest output from the lowpass noise reduction unit 105.

The band combining unit 106 inputs these signals, combines the noise-reduced highpass signal and the noise-reduced lowpass signal of the local region of interest, and outputs a combined result as a noise-reduced (NR) local region image 116 illustrated in FIG. 4.

The band combining unit 106 performs the combining process by adding the highpass component and the lowpass component.

The above-described band separation unit 103 calculates each pixel value (A^{high}_{x,y}) of the highpass signal according to the foregoing (Equation 4), that is, the following (Equation 4).

A^{high}_{x,y}=A_{x,y}−A^{low}_{x,y} (Equation 4)

Here, in the foregoing (Equation 4), each parameter is as follows:

A: each pixel color of an image to be processed and one of R, G, and B in a case of a Bayer array,

A_{x,y}: a pixel value at the coordinate (x, y) position of an input local region image to be processed,

A^{low}_{x,y}: a pixel value at the coordinate (x, y) position of lowpass signal image data, and

A^{high}_{x,y}: a pixel value at the coordinate (x, y) position of highpass signal image data.

The band combining unit 106 inputs the pixel value (A^{high}_{x,y}) of the highpass signal and the pixel value (A^{low}_{x,y}) of the lowpass signal and calculates the pixel value (A_{x,y}) at the coordinate (x, y) position of the input local region image. The pixel value (A_{x,y}) can be calculated according to the following (Equation 6) derived from the foregoing (Equation 4).

A_{x,y}=A^{high}_{x,y}+A^{low}_{x,y} (Equation 6)

Here, in the foregoing (Equation 6), each parameter is the same as that of the foregoing (Equation 4) and is as follows:

A: each pixel color of an image to be processed and one of R, G and B in a case of a Bayer array,

A_{x,y}: a pixel value at the coordinate (x, y) position of an input local region image to be processed,

A^{low}_{x,y}: a pixel value at the coordinate (x, y) position of lowpass signal image data, and

A^{high}_{x,y}: a pixel value at the coordinate (x, y) position of highpass signal image data.

The band combining unit 106 generates an image obtained by performing the noise reduction process on the local region of interest according to the foregoing (Equation 6), that is, the noise-reduced local region image 116, and outputs the noise-reduced local region image 116 to the local region combining unit 107.

In the configuration of the RAW noise reduction unit 31 illustrated in FIG. 4, the processes from the local region selection unit 101 to the band combining unit 106 are performed in units of the local regions of interest selected by the local region selection unit 101.

For example, the local region selection unit 101 sequentially selects local regions of interest by shifting one pixel to several pixels.

Various methods can be used as a method of setting the local region of interest. For example, the local regions of interest are set sequentially by shifting one pixel. That is, the local region of interest is set such that each local region of interest has an overlapping region.

Thus, the band combining unit 106 sequentially outputs the local region-of-interest images from which the noise is reduced. The output noise-reduced local region-of-interest image is an image including the overlapping region.

[2-9. Process of Local Region Combining Unit]

The local region combining unit 107 sequentially inputs the noise-reduced local region images 116, which are the local region images from which the noise is reduced, from the band combining unit 106, combines the input local region images to generate one noise-reduced RAW image 117, and outputs the noise-reduced RAW image 117.

The noise-reduced local region images 116 input from the band combining unit 106 are noise-reduced local region images corresponding to the local regions of interest sequentially selected by the local region selection unit 101.

The local region selection unit 101 sets the local region of interest as the noise reduction processing target from the RAW image 51, which is an input image, by shifting a pixel position little by little.

The local region of interest is, for example, a local region that includes an overlapping pixel region

Accordingly, each of the noise-reduced local region images 116 sequentially input from the band combining unit 106 is also image data that includes an overlapping pixel region. The local region combining unit 107 performs a combining process in consideration of the overlapping region. For example, when n noise-reduced local region images are input for one pixel, a final pixel value is calculated by adding the corresponding pixel values of the noise-reduced local region images and dividing the addition result by the number of overlaps n.

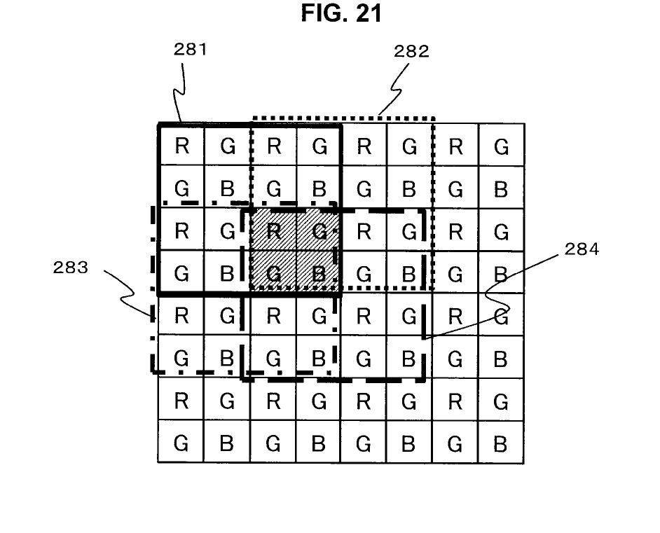

A setting example of the noise-reduced local region images including the overlapping pixel region and input from the band combining unit 106 is illustrated in FIG. 21. FIG. 21 illustrates 4 noise-reduced local region images 281 to 284 with 4×4 pixels. Each of these regions includes an overlapping pixel region.

For example, 4 pixels indicated by diagonal lines in FIG. 21 are a pixel region that is included in all of the 4 noise-reduced local region images 281 to 284 with 4×4 pixels.

In the 4 pixels indicated by the diagonal lines, pixel values are set in the 4 noise-reduced local region images 281 to 284.

In this case, the local region combining unit 107 calculates an average value of the following pixel values set in the 4 local region pixels with regard to the 4 pixels (R, G, G, and B) indicated by the diagonal lines and sets the average value as a pixel value of the noise-reduced RAW image 117.

That is, an addition average value of the following pixel values a, b, c, and d is X=(a+b+c+d)/4:

a pixel value a set in the noise-reduced local region image 281,

a pixel value b set in the noise-reduced local region image 282,

a pixel value c set in the noise-reduced local region image 283, and

a pixel value d set in the noise-reduced local region image 284.

The value X calculated according to the foregoing calculation equation is set as the pixel value of the noise-reduced RAW image 117.

Thus, accuracy of the noise reduction in an output image can be further improved by setting the pixel value of the final output image through the process of averaging the corresponding pixel values of the plurality of noise-reduced local region images.

[3. Whole Sequence of Noise Reduction Process]

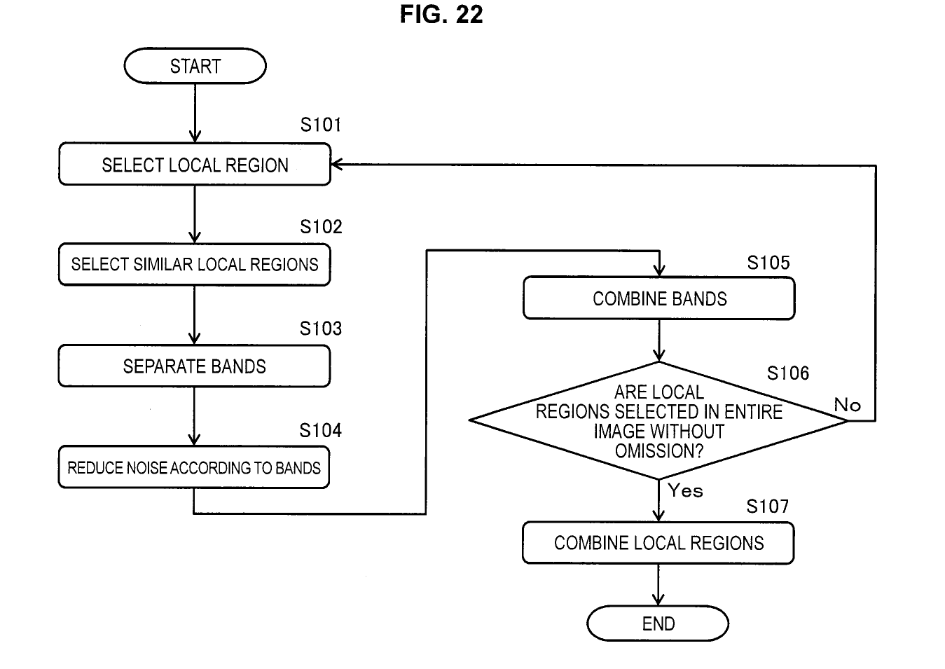

Next, a whole sequence of the above-described noise reduction process on the RAW image, that is, the noise reduction process performed by the RAW noise reduction unit 31 having the configuration illustrated in FIG. 4, will be described with reference to the flowchart illustrated in FIG. 22.

The process illustrated in FIG. 22 is a process that is performed by the RAW noise reduction unit 31 of the image processing unit 16 of the imaging device 10 described with reference to FIGS. 1, 3, and 4. For example, this process is performed when the control unit 25 performs control of the image processing unit 16 according to a program stored in the memory 18 of the imaging device 10 illustrated in FIG. 1.

Hereinafter, processes of steps of the flowchart illustrated in FIG. 22 will be described.

### (S101)

First, in step S101, a RAW image which is a captured image with a specific color filter array such as an RGB Bayer array input from the image sensor is input and a local region which is a noise reduction target is selected as a local region of interest from the RAW image.

This process is a process performed by the local region selection unit 101 illustrated in FIG. 4. For example, a local region of interest with n×n pixels is selected.

### (S102)

Next, in step S102, a plurality of similar local regions that have high similarity to the local region of interest and have the same phase as the local region of interest are selected from the periphery of the local region of interest selected in step S101.

This process is a process performed by the similar local region selection unit 102 illustrated in FIG. 4.

As described above with reference to FIG. 5, this process is, for example, a process of allowing the similar local region selection unit 102 to search for and extract a predetermined number of local regions Pi (where i=1, 2, 3, . . . ) with high similarity due to the same phase as the local region of interest Pr210 from the search region 202 set centering on the local region of interest Pr210 and selected as a noise reduction processing target region by the local region selection unit 101 in order from the most similar.

With regard to the similarity, Sum of Absolute Differences (SAD) or Sum of Squares Differences (SSD) based on pixel values between the local regions is used. The local regions in which a value of the SAD or the SSD with the local region of interest is small are sequentially selected.

### (S103)

Next, in step S103, the band separation process is performed on each local region group selected in step S101 and step S102, that is, each local region group including the local region of interest and the plurality of similar local regions. Specifically, the pixel signal of each local region is separated into a lowpass signal and a highpass signal.

This process is the process performed by the band separation unit 103 illustrated in FIG. 4 and is the process described above with reference to FIG. 6. For example, a lowpass signal image and a highpass signal image corresponding to each local region are generated applying the foregoing (Equation 3) and (Equation 4).

### (S104)

Next, in step S104, the noise reduction process is performed on each of the highpass signal images and the lowpass signal images corresponding to the local region of interest and the plurality of similar local regions generated in step S103. That is, the noise reduction process is performed according to the bands of the highpass and the lowpass.

This process is the process performed by the highpass noise reduction unit 104 and the lowpass noise reduction unit 105 illustrated in FIG. 4.

The highpass noise reduction unit 104 generates, for example, 3-dimensional data including the highpass signal image of each local region described above with reference to FIG. 7 and performs the process of reducing the noise contained in the highpass signal applying the 3-dimensional data.

Specifically, as described above with reference to FIGS. 8 to 18, the noise reduction process is performed according to one of the following (1st processing example) to (3rd processing example):

(1st processing example) the noise reduction process by the 3-dimensional wavelet shrinkage according to the flowchart illustrated in FIG. 8,

(2nd processing example) the noise reduction process by the 2-dimensional wavelet transform+the ε filter (epsilon filter) according to the flowchart illustrated in FIG. 17, and

(3rd processing example) the noise reduction process by the ε filter (epsilon filter) of the Z direction according to the flowchart illustrated in FIG. 18.

The highpass noise reduction unit 104 performs the process of reducing the noise contained in the highpass signal by performing one of the foregoing (1st processing example) to (3rd processing example) applying the 3-dimensional data including the highpass signal image of each local region illustrated in FIG. 7.

As in the highpass noise reduction unit 104, the lowpass noise reduction unit 105 generates 3-dimensional data including the same lowpass signal image of each local region as the highpass signal image of each local region illustrated in FIG. 7 and performs the process of reducing the noise contained in the lowpass signal applying the 3-dimensional data.

Specifically, as described above with reference to FIGS. 19 and 20, the noise reduction process is performed according to one of the following (1st processing example) and (2nd processing example):

(1st processing example) the noise reduction process of performing the 1-dimensional wavelet shrinkage on each piece of the 1-dimensional data including average (DC) signal of same color (R, G, or B) in units of the local regions in each of the local region of interest and a plurality of similar local regions, and

(2nd processing example) the noise reduction process of applying the ε filter (epsilon filter) to each piece of the 1-dimensional data including average (DC) signal of same color (R, G, or B) in units of the local regions in the local region of interest and a plurality similar local regions.

The lowpass noise reduction unit 105 generates 3-dimensional data including the same lowpass signal image of each local region as the highpass signal image of each local region illustrated in FIG. 7 and performs the process of reducing the noise contained in the lowpass signal by performing one of the foregoing (1st processing example) and (2nd processing example) applying the 3-dimensional data.

### (S105)

Next, in step S105, the band signals from which the noise is reduced in step S104 are combined to generate the noise-reduced local region images.

This process is a process performed by the band combining unit 106 illustrated in FIG. 4.

The band combining unit 106 inputs the following signals:

the highpass signal after the noise reduction corresponding to the local region of interest output from the highpass noise reduction unit 104, and

the lowpass signal after the noise reduction corresponding to the local region of interest output from the lowpass noise reduction unit 105.

The band combining unit 106 inputs these signals, combines the noise-reduced highpass signal and the noise-reduced lowpass signal of the local region of interest, and outputs the combining result as the noise-reduced (NR) local region image 116 illustrated in FIG. 4.

The signal value (pixel value) as the result of the combining process can be calculated according to (Equation 6) described above.

A_{x,y}=A^{high}_{x,y}+A^{low}_{x,y} (Equation 6)

Here, in the foregoing (Equation 6), each parameter is as follows:

A: each pixel color of an image to be processed and one of R, G, and B in a case of a Bayer array,

A_{x,y}: a pixel value at the coordinate (x, y) position of an input local region image to be processed,

A^{low}_{x,y}: a pixel value at the coordinate (x, y) position of lowpass signal image data, and

A^{high}_{x,y}: a pixel value at the coordinate (x, y) position of highpass signal image data.

The band combining unit 106 generates the noise-reduced local region image 116 in which the noise is reduced in the local region of interest according to the foregoing (Equation 6) and outputs the noise-reduced local region image 116 to the local region combining unit 107.

### (S106)

Next, in step S106, it is determined whether the process on the entire image is completed. Specifically, it is determined whether the local regions of interest selected sequentially in step S101 include all of the regions of the input image.

When it is determined that the local regions of interest selected sequentially in step S101 include all of the regions of the input image and the process is completed on the entire image, the process proceeds to step S107. When there is an unprocessed region, the process returns to step S101, the process for the unprocessed region is performed, that is, a new local region of interest is selected.

### (S107)

When it is determined in step S106 that the process on all of the image regions is completed, the process of combining the noise-reduced local regions obtained by repeating step S101 to step S106 is performed to generate the noise-reduced RAW image and the noise-reduced RAW image is output in step S107.

This process is the process performed by the local region combining unit 107 illustrated in FIG. 4.

As illustrated in FIG. 4, the local region combining unit 107 sequentially inputs the noise-reduced local region images 116, which are the local region images in which the noise is reduced, from the band combining unit 106, generates one noise-reduced RAW image 117 by combining the input local region images, and outputs the noise-reduced RAW image 117.

As described above with reference to FIG. 21, the noise-reduced local region images 116 input from the band combining unit 106 are, for example, local region image data having the overlapping region. The local region combining unit 107 performs the combining process in consideration of the overlapping region. For example, when n noise-reduced local region images are input for one pixel, a final pixel value is calculated by adding the corresponding pixel values of the noise-reduced local region images and dividing the sum by the number of overlaps n.

The RAW noise reduction unit 31 of the image processing unit 16 of the imaging device 10 illustrated in FIG. 1 generates the RAW image in which the noise is reduced through this process and outputs the RAW image to the camera signal processing unit 32 at the subsequent stage.

The camera signal processing unit 32 inputs the color-array image (RAW image) in which the noise is reduced by the RAW noise reduction unit 31, performs a demosaicing process of restoring all of the colors in the respective pixels through signal processing or other general camera signal processing, generates an output image, and outputs the output image as a memory storage image or a display image for the display unit.

[4. Second Embodiment of Noise Reduction Process Performed by Image Processing Device According to an Embodiment of the Present Disclosure]

Next, a second embodiment of the noise reduction process performed by the image processing unit 16 of the imaging device 10 illustrated in FIG. 1 will be described.

In the second embodiment, the configuration of the imaging device 10 is the same as the configuration illustrated in FIG. 1 according to the first embodiment.

The configuration of the image processing unit 16 is the same as the configuration illustrated in FIG. 3 according to the first embodiment. The image processing unit 16 includes a RAW noise reduction unit 31 and a camera signal processing unit 32.

However, the configuration of the RAW noise reduction unit 31 is different from the configuration illustrated in FIG. 4 and described above in the first embodiment.

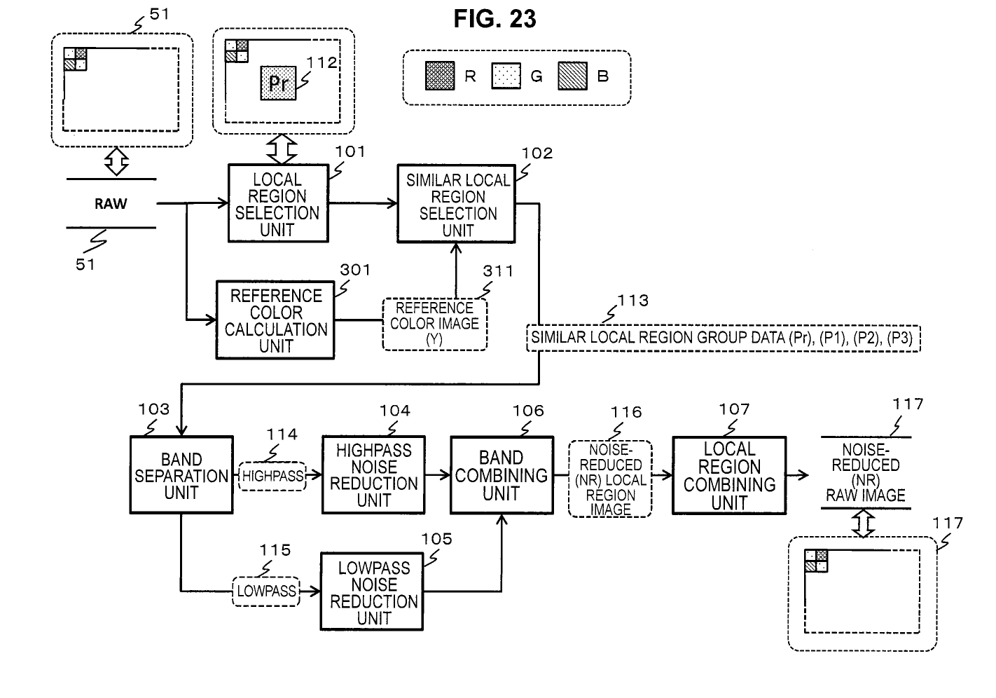

The configuration of the RAW noise reduction unit 31 in the second embodiment is illustrated in FIG. 23.

Most of the configuration of the RAW noise reduction unit 31 illustrated in FIG. 23 according to the second embodiment is common to the configuration of the RAW noise reduction unit described above with reference to FIG. 4 in the first embodiment.

The RAW noise reduction unit 31 illustrated in FIG. 23 according to the second embodiment includes a reference color calculation unit 301 which is not included in the RAW noise reduction unit described above with reference to FIG. 4 according to the first embodiment.

The reference color calculation unit 301 inputs a RAW image 51 which is captured by an image sensor and in which only a one specific color is set in each pixel, calculates a reference color, such as luminance (Y), corresponding to each pixel position of the input RAW image 51, and outputs this image as a reference color image 311 to the similar local region selection unit 102.

The RAW image input from the image sensor by the reference color calculation unit 301 is, for example, a RAW image that has a Bayer array in which only a pixel value of one color of RGB is set in each pixel, as described above with reference to FIG. 2.

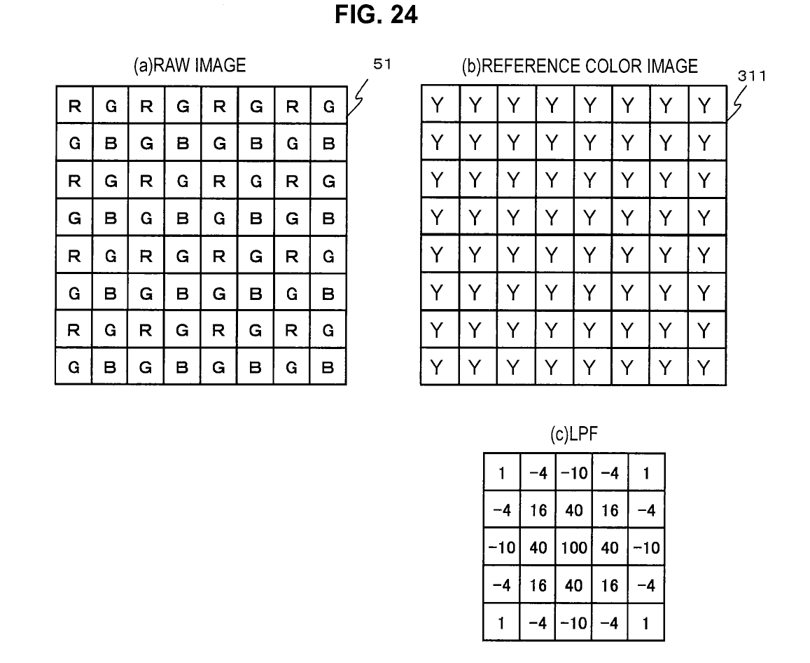

A process performed by the reference color calculation unit 301 will be described with reference to FIG. 24.

FIG. 24(a) illustrates the RAW image 51 input from the image sensor by the reference color calculation unit 301.

FIG. 24(b) illustrates a reference color image (luminance (Y) image) generated based on the RAW image 51 by the reference color calculation unit 301.

As illustrated in FIG. 24(b), the reference color calculation unit 301 sets the reference color (luminance (Y)) at all of the pixel positions.

Various methods can be applied as a method of calculating and processing the reference color (luminance (Y)) corresponding to each pixel position of the RAW image 51. For example, a process of applying a lowpass filter (LPF) illustrated in FIG. 24(c) is used as an example.

A lowpass filter illustrated in FIG. 24(c) has a configuration corresponding to 5×5 pixels and is applied to calculate the reference color (luminance(Y)) at the center position in units of 5×5 pixels of the RAW image.

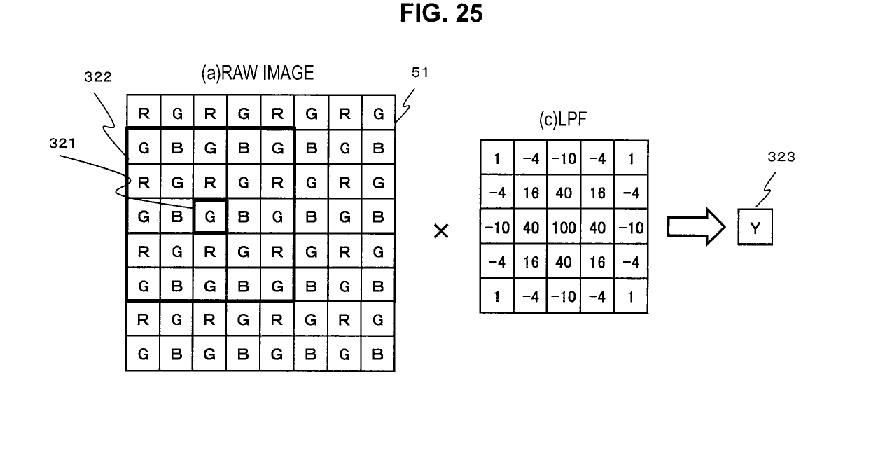

For example, as illustrated in FIG. 25, when a reference color (Y) pixel value 323 corresponding to one G pixel 321 of the RAW image 51 is calculated, the reference color (Y) pixel value 323 is calculated by setting a 5×5 pixel region 322 centering on the G pixel 321, multiplying the pixel values of pixels of the 5×5 pixel region 322 by coefficients of corresponding pixel positions of an LPF in FIG. 25(c), and performing a calculation process of adding all of the multiplication results of the pixels.

The reference color pixel value corresponding to each pixel position of the RAW image 51 is calculated by performing a process of applying the LPF to the constituent pixels of the RAW image 51, and the result is output as the reference color image 311 illustrated in FIG. 24(b) to the similar local region selection unit 102, as illustrated in FIG. 23.

By applying the lowpass filter (LPF) illustrated in FIGS. 24(c) and 25(c), the reference color (luminance (Y)) of more lowpass than a sampling frequency of the input RAW image 51 can be set in all of the pixels. In this example, the reference color corresponding to the luminance contributed by the RGB is calculated through the process of applying the filter illustrated in FIG. 24(c). However, for example, by applying only G pixel information of the RAW image 51, the reference color may be set to be calculated.

The similar local region selection unit 102 inputs the followings:

a local region of interest selected by the local region selection unit 101, and

the reference color image 311 generated by the reference color calculation unit 301.

As in the above-described first embodiment, the similar local region selection unit 102 searches for and selects a plurality of similar local regions that have the same phase as the local region of interest selected by the local region selection unit 101 and have high similarity from regions in the periphery of the local region of interest.

In the above-described first embodiment, the similar local region selection unit 102 performed the process of applying the RAW image 51 to determine the similarity. That is, for example, the process of sequentially selecting the local regions that have a small value of the SAD or the SSD with the local region of interest has been performed using Sum of Absolute Differences (SAD) or Sum of Squares Differences (SSD) based on pixel values between the local regions.

On the other hand, the similar local region selection unit 102 according to the second embodiment applies the reference color image 311 rather than the RAW image 51 to determine the similarity.

To determine the phase, the RAW image 51 is applied. Thereafter, to determine the similarity, the reference color image 311 is applied.

Sum of Absolute Differences (SAD) or Sum of Squares Differences (SSD) is calculated based on constituent pixel values of the reference color image 311, and the local regions that have the small value of the SAD or the SSD with the local region of interest are sequentially selected.

Since the reference color image 311 includes signals with lower frequency than the RAW image 51, there is the advantage that the searching of the similar local region is robust against noise. Therefore, the stable similarity determination result can be obtained.

[5. Sequence of Noise Reduction Process According to Second Embodiment]

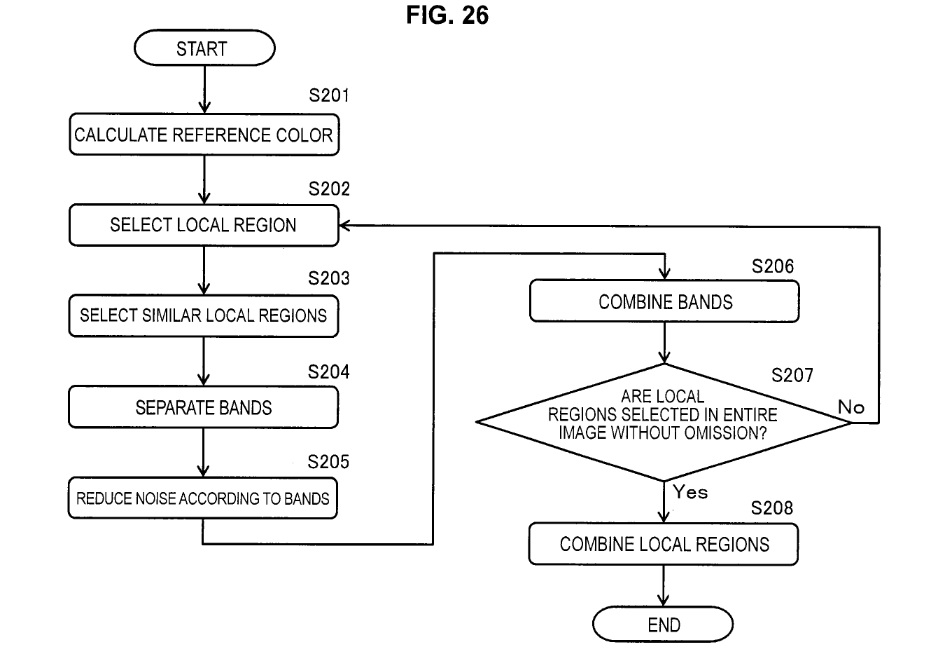

Next, a whole sequence of the above-described noise reduction process on the RAW image in the above-described second embodiment, that is, the noise reduction process performed by the RAW noise reduction unit 31 having the configuration illustrated in FIG. 23, will be described with reference to the flowchart illustrated in FIG. 26.

The process illustrated in FIG. 26 is a process that is performed by the RAW noise reduction unit 31 of the image processing unit 16 of the imaging device 10 described with reference to FIGS. 1, 3, and 23. For example, this process is performed when the control unit 25 performs control of the image processing unit 16 according to a program stored in the memory 18 of the imaging device 10 illustrated in FIG. 1.

Hereinafter, processes of steps of the flowchart illustrated in FIG. 26 will be described.

The processing order of step S202 to step S208 of the flow illustrated in FIG. 26 is the same as the processing order of step S101 to step S107 of the flow illustrated in FIG. 22 and described above in the first embodiment. The flow illustrated in FIG. 26 differs in that a process of step S201 illustrated in FIG. 26 is added before the process of step S101 of the flow illustrated in FIG. 22.

Hereinafter, a noise reduction process according to the second embodiment will be described.

### (S201)

First, in step S201, a RAW image which is a captured image with a specific color filter array such as an RGB Bayer array input from the image sensor is input, a reference color, such as a luminance value (Y), corresponding to each pixel of the RAW image is calculated, and a reference color image in which the reference color is set in all of the pixels of the RAW image is generated.

This process is a process performed by the reference color calculation unit 301 illustrated in FIG. 23.

As described above with reference to FIG. 24 and FIG. 25, for example, the reference color calculation unit 301 calculates the reference color set in each pixel of the RAW image applying the lowpass filter, for example, the pixel value of the luminance value (Y) and generates the reference color image.

### (S202)

In step S202, the RAW image which is the captured image with the specific color filter array such as an RGB Bayer array input from the image sensor is input and a local region which is a noise reduction target is selected as a local region of interest from the RAW image.

This process is a process performed by the local region selection unit 101 illustrated in FIG. 23. For example, a local region of interest with n×n pixels is selected.

### (S203)

Next, in step S203, a plurality of similar local regions that have high similarity to the local region of interest and have the same phase as the local region of interest are selected from the periphery of the local region of interest selected in step S201.

This process is a process performed by the similar local region selection unit 102 illustrated in FIG. 23.

As described above with reference to FIG. 5, this process is, for example, a process of allowing the similar local region selection unit 102 to search for and extract a predetermined number of local regions Pi (where i=1, 2, 3, . . . ) with high similarity due to the same phase as the local region of interest Pr210 from the search region 202 set centering on the local region of interest Pr210 and selected as a noise reduction processing target region by the local region selection unit 101 in order from the most similar.

In this embodiment, with regard to the similarity, the reference color image generated in step S201 by the reference color calculation unit 301 is used. Sum of Absolute Differences (SAD) or Sum of Squares Differences (SSD) based on pixel values between the local regions in the reference color image is used. The local regions that have the small value of the SAD or the SSD with the local region of interest are sequentially selected.

### (S204)

Next, in step S204, the band separation process is performed on each local region group selected in step S202 and step S203, that is, each local region group including the local region of interest and the plurality of similar local regions. Specifically, the pixel signal of each local region is separated into a lowpass signal and a highpass signal.

This process is the process performed by the band separation unit 103 illustrated in FIG. 23 and is the process described above with reference to FIG. 6. For example, a lowpass signal image and a highpass signal image corresponding to each local region are generated applying the foregoing (Equation 3) and (Equation 4).

### (S205)

Next, in step S205, the noise reduction process is performed on each of the highpass signal images and the lowpass signal images corresponding to the local region of interest and the plurality of similar local regions generated in step S204. That is, the noise reduction process is performed according to the bands of the highpass and the lowpass.

This process is the process performed by the highpass noise reduction unit 104 and the lowpass noise reduction unit 105 illustrated in FIG. 23.

The highpass noise reduction unit 104 generates, for example, 3-dimensional data including the highpass signal image of each local region described above with reference to FIG. 7 and performs the process of reducing the noise contained in the highpass signal applying the 3-dimensional data.

Specifically, as described above with reference to FIGS. 8 to 18, the noise reduction process is performed according to one of the following (1st processing example) to (3rd processing example):

(1st processing example) the noise reduction process by the 3-dimensional wavelet shrinkage according to the flowchart illustrated in FIG. 8,

(2nd processing example) the noise reduction process by the 2-dimensional wavelet transform+the ε filter (epsilon filter) according to the flowchart illustrated in FIG. 17, and

(3rd processing example) the noise reduction process by the ε filter (epsilon filter) of the Z direction according to the flowchart illustrated in FIG. 18.

The highpass noise reduction unit 104 performs the process of reducing the noise contained in the highpass signal by performing one of the foregoing (1st processing example) to (3rd processing example) applying the 3-dimensional data including the highpass signal image of each local region illustrated in FIG. 7.

As in the highpass noise reduction unit 104, the lowpass noise reduction unit 105 generates 3-dimensional data including the same lowpass signal image of each local region as the highpass signal image of each local region illustrated in FIG. 7 and performs the process of reducing the noise contained in the lowpass signal applying the 3-dimensional data.

Specifically, as described above with reference to FIGS. 19 and 20, the noise reduction process is performed according to one of the following (1st processing example) and (2nd processing example):

(1st processing example) the noise reduction process of performing the 1-dimensional wavelet shrinkage on each piece of the 1-dimensional data including average (DC) signal of same color (R, G, or B) in units of the local regions in each of the local region of interest and a plurality of similar local regions, and

(2nd processing example) the noise reduction process of applying the ε filter (epsilon filter) to each piece of the 1-dimensional data including average (DC) signal of same color (R, G, or B) in units of the local regions in the local region of interest and a plurality similar local regions.

The lowpass noise reduction unit 105 generates 3-dimensional data including the same lowpass signal image of each local region as the highpass signal image of each local region illustrated in FIG. 7 and performs the process of reducing the noise contained in the lowpass signal by performing one of the foregoing (1st processing example) and (2nd processing example) applying the 3-dimensional data.

### (S206)

Next, in step S206, the band signals in which the noise is reduced in step S205 are combined to generate the noise-reduced local region images.

This process is a process performed by the band combining unit 106 illustrated in FIG. 23.

The band combining unit 106 inputs the following signals:

the highpass signal after the noise reduction corresponding to the local region of interest output from the highpass noise reduction unit 104, and

the lowpass signal after the noise reduction corresponding to the local region of interest output from the lowpass noise reduction unit 105.

The band combining unit 106 inputs these signals, combines the noise-reduced highpass signal and the noise-reduced lowpass signal of the local region of interest, and outputs the combining result as the noise-reduced (NR) local region image 116 illustrated in FIG. 4.

The signal value (pixel value) as the result of the combining process can be calculated according to (Equation 6) described above.

A_{x,y}=A^{high}_{x,y}+A^{low}_{x,y} (Equation 6)

Here, in the foregoing (Equation 6), each parameter is as follows:

A: each pixel color of an image to be processed and one of R, G, and B in a case of a Bayer array,

A_{x,y}: a pixel value at the coordinate (x, y) position of an input local region image to be processed,

A^{low}_{x,y}: a pixel value at the coordinate (x, y) position of lowpass signal image data, and

A^{high}_{x,y}: a pixel value at the coordinate (x, y) position of highpass signal image data.

The band combining unit 106 generates the noise-reduced local region image 116 from which the noise is reduced in the local region of interest according to the foregoing (Equation 6) and outputs the noise-reduced local region image 116 to the local region combining unit 107.

### (S207)

Next, in step S207, it is determined whether the process on the entire image is completed. Specifically, it is determined whether the local regions of interest selected sequentially in step S202 include all of the regions of the input image.

When it is determined that the local regions of interest selected sequentially in step S202 include all of the regions of the input image and the process is completed on the entire image, the process proceeds to step S208. When there is an unprocessed region, the process returns to step S202, the process for the unprocessed region is performed, that is, a new local region of interest is selected.

### (S208)

When it is determined in step S207 that the process on all of the image regions is completed, the process of combining the noise-reduced local regions obtained by repeating step S202 to step S207 is performed to generate the noise-reduced RAW image and the noise-reduced RAW image is output in step S208.

This process is the process performed by the local region combining unit 107 illustrated in FIG. 23.

As illustrated in FIG. 23, the local region combining unit 107 sequentially inputs the noise-reduced local region images 116, which are the local region images in which the noise is reduced, from the band combining unit 106, generates one noise-reduced RAW image 117 by combining the input local region images, and outputs the noise-reduced RAW image 117.

As described above with reference to FIG. 21, the noise-reduced local region images 116 input from the band combining unit 106 are, for example, local region image data having the overlapping region. The local region combining unit 107 performs the combining process in consideration of the overlapping region. For example, when n noise-reduced local region images are input for one pixel, a final pixel value is calculated by adding the corresponding pixel values of the noise-reduced local region images and dividing the addition result by the number of overlaps n.

In the second embodiment, the RAW noise reduction unit 31 of the image processing unit 16 of the imaging device 10 illustrated in FIG. 1 generates the RAW image in which the noise is reduced through this process and outputs the RAW image to the camera signal processing unit 32 at the subsequent stage.

The camera signal processing unit 32 inputs the color-array image (RAW image) in which the noise is reduced by the RAW noise reduction unit 31, performs a demosaicing process of restoring all of the colors in the respective pixels through signal processing or other general camera signal processing, generates an output image, and outputs the output image as a memory storage image or a display image for the display unit.

In the above-described embodiment, the RAW image set as the processing target image has been described as an image that has the Bayer array. The process according to an embodiment of the present disclosure is not limited to the Bayer array, but may also be applied to a RAW image with another color array.

[6. Summarization of Configuration According to Embodiments of the Present Disclosure]

The embodiments of the present disclosure have been described above in detail with reference to the specific embodiments. However, it is apparent to those skilled in the art that corrections or substitutions of the embodiments are made within the scope of the present disclosure without departing from the gist of the present disclosure. That is, since the present disclosure has been described in the form of examples, the present disclosure should not be construed as being limited. To determine the gist of the present disclosure, the claims should be referred to.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image processing device including:

an image processing unit that sets a RAW image in which a pixel value of a specific color is set in each pixel as an input image and reduces a noise component contained in the input image,

wherein the image processing unit includes
a local region selection unit that selects each local region of interest as a processing target region from the input image,
a similar local region selection unit that selects similar local regions which have the same phase as the local region of interest and have high similarity to the local region of interest,
a band separation unit that separates local regions in each of the local region of interest and the similar local regions into band-classified signals including a highpass signal and a lowpass signal,
a band-classified noise reduction unit that performs a process of reducing noise contained in the band-classified signals generated in the band separation unit,
a band combining unit that combines band-classified signals after the noise reduction generated by the band-classified noise reduction unit to generate noise-reduced local region-of-interest images, and
a local region combining unit that sequentially inputs the noise-reduced local region-of-interest images generated by the band combining unit and generates a noise-reduced RAW image through an input image combining process.

(2) The image processing device according to (1),

wherein the band-classified noise reduction unit generates 3-dimensional data in which the highpass signals of the local region of interest and the similar local regions are set in XY planes and are superimposed in a Z-axis direction, and

wherein the band-classified noise reduction unit performs the noise reduction process on the highpass signal of the local region of interest by sequentially performing the following processes of (a) to (e) applying the 3-dimensional data:
(a) a process of generating a plurality of pieces of 2-dimensional wavelet transform data corresponding to local regions through a 2-dimensional wavelet transform process on the highpass signal of each local region which is XY plane data,
(b) a process of generating a plurality of pieces of 1-dimensional wavelet transform data through a 1-dimensional wavelet transform process on each of 1-dimensional pixel rows in the Z-axis direction generated from the plurality of pieces of 2-dimensional wavelet transform data corresponding to the local regions,
(c) a shrinkage process on each of the plurality of pieces of 1-dimensional wavelet transform data,
(d) a 1-dimensional wavelet inverse-transform process on each of the plurality of pieces of 1-dimensional wavelet transform data after the shrinkage process, and
(e) a 2-dimensional wavelet inverse-transform process on an XY plane signal corresponding to the local region of interest formed by data after the 1-dimensional wavelet inverse-transform process.

(3) The image processing device according to (2),

wherein the band-classified noise reduction unit generates 3-dimensional data in which the lowpass signals of the local region of interest and the similar local regions are set in the XY planes and are superimposed in the Z-axis direction, and

wherein the band-classified noise reduction unit performs the noise reduction process on the lowpass signal of the local region of interest through an c filter (epsilon filter) application process on each of the plurality of pieces of 1-dimensional data in the Z-axis direction generated from the 3-dimensional data.

(4) The image processing device according to (1) or (2),

wherein the band-classified noise reduction unit generates 3-dimensional data in which the lowpass signals of the local region of interest and the similar local regions are set in the XY planes and are superimposed in the Z-axis direction, and

wherein the band-classified noise reduction unit performs the noise reduction process on the lowpass signal of the local region of interest by sequentially performing the following processes of (a) to (c) applying the 3-dimensional data:

(a) a process of generating a plurality of pieces of 1-dimensional wavelet transform data through a 1-dimensional wavelet transform process on each of the plurality of pieces of 1-dimensional data in the Z-axis direction generated from the 3-dimensional data,

(b) a shrinkage process on each of the plurality of pieces of 1-dimensional wavelet transform data, and

(c) a 1-dimensional wavelet inverse-transform process on each of the plurality of pieces of 1-dimensional wavelet transform data after the shrinkage process.

(5) The image processing device according to (1),

wherein the band-classified noise reduction unit generates 3-dimensional data in which the highpass signals of the local region of interest and the similar local regions are set in XY planes and are superimposed in a Z-axis direction, and

wherein the band-classified noise reduction unit performs the noise reduction process on the highpass signal of the local region of interest by sequentially performing the following processes of (a) to (c) applying the 3-dimensional data:
(a) a process of generating a plurality of pieces of 2-dimensional wavelet transform data corresponding to the local regions through a 2-dimensional wavelet transform process on the highpass signal of each local region which is XY plane data,
(b) an ε filter (epsilon filter) application process on each of the 1-dimensional pixel rows in the Z-axis direction generated from the plurality of pieces of 2-dimensional wavelet transform data corresponding to the local regions, and
(c) a 2-dimensional wavelet inverse-transform process on data after the filter (epsilon filter) application process.

(6) The image processing device according to (5),

wherein the band-classified noise reduction unit generates 3-dimensional data in which the lowpass signals of the local region of interest and the similar local regions are set in the XY planes and are superimposed in the Z-axis direction, and

wherein the band-classified noise reduction unit performs the noise reduction process on the lowpass signal of the local region of interest through the ε filter (epsilon filter) application process on each of the plurality of pieces of 1-dimensional data in the Z-axis direction generated from the generated 3-dimensional data.

(7) The image processing device according to (5),

wherein the band-classified noise reduction unit generates 3-dimensional data in which the lowpass signals of the local region of interest and the similar local regions are set in the XY planes and are superimposed in the Z-axis direction, and

wherein the band-classified noise reduction unit performs the noise reduction process on the lowpass signal of the local region of interest by sequentially performing the following processes of (a) to (c) applying the 3-dimensional data:
(a) a process of generating a plurality of pieces of 1-dimensional wavelet transform data through a 1-dimensional wavelet transform process on each of a plurality of pieces of 1-dimensional data in the Z-axis direction generated from the 3-dimensional data,
(b) a shrinkage process on each of the plurality of pieces of 1-dimensional wavelet transform data, and
(c) a 1-dimensional wavelet inverse-transform process on each of the plurality of pieces of 1-dimensional wavelet transform data after the shrinkage process.

(8) The image processing device according to (1),

wherein the band-classified noise reduction unit generates 3-dimensional data in which the highpass signals of the local region of interest and the similar local regions are set in XY planes and are superimposed in a Z-axis direction, and

wherein the band-classified noise reduction unit performs the noise reduction process on the highpass signal of the local region of interest through an ε filter (epsilon filter) application process on each of a plurality of pieces of 1-dimensional data in the Z-axis direction generated from the 3-dimensional data.

(9) The image processing device according to (8),

wherein the band-classified noise reduction unit generates 3-dimensional data in which the lowpass signals of the local region of interest and the similar local regions are set in the XY planes and are superimposed in the Z-axis direction, and

wherein the band-classified noise reduction unit performs the noise reduction process on the lowpass signal of the local region of interest through the c filter (epsilon filter) application process on each of the plurality of pieces of 1-dimensional data in the Z-axis direction generated from the generated 3-dimensional data.

(10) The image processing device according to (8),

wherein the band-classified noise reduction unit generates 3-dimensional data in which the lowpass signals of the local region of interest and the similar local regions are set in the XY planes and are superimposed in the Z-axis direction, and

wherein the band-classified noise reduction unit performs the noise reduction process on the lowpass signal of the local region of interest by sequentially performing the following processes of (a) to (c) applying the 3-dimensional data:
(a) a process of generating a plurality of pieces of 1-dimensional wavelet transform data through a 1-dimensional wavelet transform process on each of the plurality of pieces of 1-dimensional data in the Z-axis direction generated from the 3-dimensional data,
(b) a shrinkage process on each of the plurality of pieces of 1-dimensional wavelet transform data, and
(c) a 1-dimensional wavelet inverse-transform process on each of the plurality of pieces of 1-dimensional wavelet transform data after the shrinkage process.

(11) The image processing device according to any one of (1) to (10),

wherein the band separation unit sets an average value in color units of the local regions in each of the local region of interest and the similar local regions as the lowpass signal corresponding to each color in each local region, and

wherein the band separation unit calculates the highpass signal corresponding to each pixel in the local regions in each of the local region of interest and the similar local regions according to the following equation:

highpass signal=(pixel value of each pixel)−(color average value corresponding each pixel).

(12) The image processing device according to any one of (1) to (11),

wherein the image processing unit further includes a reference color calculation unit that generates a reference color image in which a reference color pixel value is set at each pixel position of the RAW image based on the RAW image,

wherein the similar local region selection unit determines similarity to the local region of interest applying the reference color image and selects similar local regions with high similarity to the local region of interest.

(13) The image processing device according to (12), wherein the reference color pixel value is a luminance value.

(14) The image processing device according to any one of (1) to (13), wherein the RAW image is a RAW image with a Bayer array.

(15) The image processing device according to any one of (1) to (14),

wherein the RAW image is a RAW image with a Bayer array,

wherein the band-classified noise reduction unit generates 3-dimensional data in which band-classified signals of the local region of interest and the similar local regions are set in XY planes and are superimposed in a Z-axis direction, and

wherein the band-classified noise reduction unit generates separation data of a luminance signal and another signal by performing a 2-dimensional wavelet transform process on the band-classified signal of each local region which is XY plane data and performs the noise reduction process applying each piece of the generated separation data.

(16) The image processing device according to any one of (1) to (15),

wherein the local region selection unit sequentially selects the local regions of interest as regions including an overlapping pixel region, and

wherein, when the local region combining unit sequentially inputs the noise-reduced local region-of-interest images including the overlapping pixel region and generates the noise-reduced RAW image through an input image combining process, the local region combining unit performs a process of averaging pixel values of the overlapping pixel region included in the plurality of noise-reduced local region-of-interest images and sets a pixel value of the noise-reduced RAW image.

(17) An image processing method performed by an image processing unit of an image processing device, the image processing device including the image processing unit that sets a RAW image in which a pixel value of a specific color is set in each pixel as an input image and reduces a noise component contained in the input image, the method including:

selecting a local region of interest as a processing target region from the input image;

selecting similar local regions which have the same phase as the local region of interest and have high similarity to the local region of interest;

separating the local regions in each of the local region of interest and the similar local regions into band-classified signals including a highpass signal and a lowpass signal;

performing a process of reducing noise contained in the band-classified signals generated in the band separation process;

combining band-classified signals after the noise reduction generated in the band-classified noise reduction process to generate noise-reduced local region-of-interest images; and

sequentially inputting the noise-reduced local region-of-interest images generated in the band combining process and generating a noise-reduced RAW image through an input image combining process.

(18) A program causing an image processing device to perform image processing, the image processing device including an image processing unit that sets a RAW image in which a pixel value of a specific color is set in each pixel as an input image and reduces a noise component contained in the input image, the program causing the image processing unit to perform:

selecting a local region of interest as a processing target region from the input image,

selecting similar local regions which have the same phase as the local region of interest and have high similarity to the local region of interest;

separating local regions in each of the local region of interest and the similar local regions into band-classified signals including a highpass signal and a lowpass signal;

performing a process of reducing noise contained in the band-classified signals generated in the band separation process;

combining band-classified signals after the noise reduction generated in the band-classified noise reduction process to generate noise-reduced local region-of-interest images; and

sequentially inputting the noise-reduced local region-of-interest images generated in the band combining process and generating a noise-reduced RAW image through the input image combining process.

Furthermore, the processing sequence that is explained in the specification can be implemented by hardware, by software and by a configuration that combines hardware and software. In a case where the processing is implemented by software, it is possible to install in memory within a computer that is incorporated into dedicated hardware a program in which the processing sequence is encoded and to execute the program. It is also possible to install a program in a general-purpose computer that is capable of performing various types of processing and to execute the program. For example, the program can be installed in advance in a storage medium. In addition to being installed in a computer from the storage medium, the program can also be received through a network, such as a local area network (LAN) or the Internet, and can be installed in a storage medium such as a hard disk or the like that is built into the computer.

Note that the various types of processing that are described in this specification may not only be performed in a temporal sequence as has been described, but may also be performed in parallel or individually, in accordance with the processing capacity of the device that performs the processing or as necessary. Furthermore, the system in this specification is not limited to being a configuration that logically aggregates a plurality of devices, all of which are contained within the same housing.

As described above, according to a configuration of an embodiment of the present disclosure, a device and a method for performing the noise reduction process on a RAW image are realized.

Specifically, a local region of interest and similar local regions having the same phase as the local region of interest are selected from the RAW image, each of the local regions is separated into band-classified signals including a highpass signal and a lowpass signal, and a process of reducing noise contained in the band-classified signals is performed. In the noise reduction process, for example, 3-dimensional data in which the highpass signals are set in XY planes and are superimposed in a Z-axis direction is generated and a noise-reduced highpass signal image of the local region of interest is generated by performing a 2-dimensional wavelet transform, a 1-dimensional wavelet transform, a shrinkage process, and 1-dimensional and 2-dimensional wavelet inverse-transforms applying the 3-dimensional data.

Even with regard to the lowpass signals, the noise is reduced through a process of applying an ε filer, a 1-dimensional wavelet transform process, or the like applying 3-dimensional data including local region of interest and similar local region data.

The RAW image from which the noise is reduced is generated by combining the bands of the highpass signals and the lowpass signals from which the noise is reduced, generating the noise-reduced images corresponding to the local regions of interest, and combining the noise-reduced images of the local regions of interest.

For example, in a process according to an embodiment of the present disclosure, since the noise is reduced in units of the local region, a risk of accuracy variability can be considerably reduced compared to a method of the related art in which noise is reduced for each pixel position. Further, since the local regions subjected to the noise reduction process are combined to generate the final noise-reduced image, addition of a noise reduction effect obtained through the combination can be expected.

Since the similar local regions are selected from the periphery using the mutual similarity of an image itself and the 3-dimensional noise reduction process is performed using the 3-dimensional data including the local region of interest and the similar local regions, the noise can be reduced with high accuracy.

The noise reduction process is performed after the band separation is performed. Therefore, correlation between colors can be used and the color of a lowpass can be preserved.

Since a noise-reduced image which has the same color filter array as an image sensor output is output, camera signal processing of the related art, such as a demosaicing process of arranging all of the colors at the pixels of the color array, can be used without change after the present process.

What is claimed is:

1. An image processing device comprising:
an image processing unit that sets a RAW image in which a pixel value of a specific color is set in each pixel as an input image and reduces a noise component contained in the input image,
wherein the image processing unit includes
a local region selection unit that selects each local region of interest as a processing target region from the input image,
a similar local region selection unit that selects similar local regions which have the same phase as the local region of interest and have high similarity to the local region of interest,
a band separation unit that separates local regions in each of the local region of interest and the similar local regions into band-classified signals including a highpass signal and a lowpass signal,
a band-classified noise reduction unit that performs a process of reducing noise contained in the band-classified signals generated in the band separation unit,
a band combining unit that combines band-classified signals after the noise reduction generated by the band-classified noise reduction unit to generate noise-reduced local region-of-interest images, and
a local region combining unit that sequentially inputs the noise-reduced local region-of-interest images generated by the band combining unit and generates a noise-reduced RAW image through an input image combining process.

2. The image processing device according to claim 1,
wherein the band-classified noise reduction unit generates 3-dimensional data in which the highpass signals of the local region of interest and the similar local regions are set in XY planes and are superimposed in a Z-axis direction, and
wherein the band-classified noise reduction unit performs the noise reduction process on the highpass signal of the local region of interest by sequentially performing the following processes of (a) to (e) applying the 3-dimensional data:
(a) a process of generating a plurality of pieces of 2-dimensional wavelet transform data corresponding to local regions through a 2-dimensional wavelet transform process on the highpass signal of each local region which is XY plane data,
(b) a process of generating a plurality of pieces of 1-dimensional wavelet transform data through a 1-dimensional wavelet transform process on each of 1-dimensional pixel rows in the Z-axis direction generated from the plurality of pieces of 2-dimensional wavelet transform data corresponding to the local regions,
(c) a shrinkage process on each of the plurality of pieces of 1-dimensional wavelet transform data,
(d) a 1-dimensional wavelet inverse-transform process on each of the plurality of pieces of 1-dimensional wavelet transform data after the shrinkage process, and
(e) a 2-dimensional wavelet inverse-transform process on an XY plane signal corresponding to the local region of interest formed by data after the 1-dimensional wavelet inverse-transform process.

3. The image processing device according to claim 2,
wherein the band-classified noise reduction unit generates 3-dimensional data in which the lowpass signals of the local region of interest and the similar local regions are set in the XY planes and are superimposed in the Z-axis direction, and
wherein the band-classified noise reduction unit performs the noise reduction process on the lowpass signal of the local region of interest through an c filter (epsilon filter) application process on each of the plurality of pieces of 1-dimensional data in the Z-axis direction generated from the 3-dimensional data.

4. The image processing device according to claim 2,
wherein the band-classified noise reduction unit generates 3-dimensional data in which the lowpass signals of the local region of interest and the similar local regions are set in the XY planes and are superimposed in the Z-axis direction, and
wherein the band-classified noise reduction unit performs the noise reduction process on the lowpass signal of the local region of interest by sequentially performing the following processes of (a) to (c) applying the 3-dimensional data:
(a) a process of generating a plurality of pieces of 1-dimensional wavelet transform data through a 1-dimensional wavelet transform process on each of the plurality of pieces of 1-dimensional data in the Z-axis direction generated from the 3-dimensional data,
(b) a shrinkage process on each of the plurality of pieces of 1-dimensional wavelet transform data, and
(c) a 1-dimensional wavelet inverse-transform process on each of the plurality of pieces of 1-dimensional wavelet transform data after the shrinkage process.

5. The image processing device according to claim 1,
wherein the band-classified noise reduction unit generates 3-dimensional data in which the highpass signals of the local region of interest and the similar local regions are set in XY planes and are superimposed in a Z-axis direction, and
wherein the band-classified noise reduction unit performs the noise reduction process on the highpass signal of the local region of interest by sequentially performing the following processes of (a) to (c) applying the 3-dimensional data:
(a) a process of generating a plurality of pieces of 2-dimensional wavelet transform data corresponding to the local regions through a 2-dimensional wavelet transform process on the highpass signal of each local region which is XY plane data,
(b) an ε filter (epsilon filter) application process on each of the 1-dimensional pixel rows in the Z-axis direction generated from the plurality of pieces of 2-dimensional wavelet transform data corresponding to the local regions, and
(c) a 2-dimensional wavelet inverse-transform process on data after the c filter (epsilon filter) application process.

6. The image processing device according to claim 5,
wherein the band-classified noise reduction unit generates 3-dimensional data in which the lowpass signals of the local region of interest and the similar local regions are set in the XY planes and are superimposed in the Z-axis direction, and
wherein the band-classified noise reduction unit performs the noise reduction process on the lowpass signal of the local region of interest through the ε filter (epsilon filter) application process on each of the plurality of pieces of 1-dimensional data in the Z-axis direction generated from the generated 3-dimensional data.

7. The image processing device according to claim 5,
wherein the band-classified noise reduction unit generates 3-dimensional data in which the lowpass signals of the local region of interest and the similar local regions are set in the XY planes and are superimposed in the Z-axis direction, and
wherein the band-classified noise reduction unit performs the noise reduction process on the lowpass signal of the local region of interest by sequentially performing the following processes of (a) to (c) applying the 3-dimensional data:
(a) a process of generating a plurality of pieces of 1-dimensional wavelet transform data through a 1-dimensional wavelet transform process on each of a plurality of pieces of 1-dimensional data in the Z-axis direction generated from the 3-dimensional data,
(b) a shrinkage process on each of the plurality of pieces of 1-dimensional wavelet transform data, and
(c) a 1-dimensional wavelet inverse-transform process on each of the plurality of pieces of 1-dimensional wavelet transform data after the shrinkage process.

8. The image processing device according to claim 1,
wherein the band-classified noise reduction unit generates 3-dimensional data in which the highpass signals of the local region of interest and the similar local regions are set in XY planes and are superimposed in a Z-axis direction, and
wherein the band-classified noise reduction unit performs the noise reduction process on the highpass signal of the local region of interest through an ε filter (epsilon filter) application process on each of a plurality of pieces of 1-dimensional data in the Z-axis direction generated from the 3-dimensional data.

9. The image processing device according to claim 8,
wherein the band-classified noise reduction unit generates 3-dimensional data in which the lowpass signals of the local region of interest and the similar local regions are set in the XY planes and are superimposed in the Z-axis direction, and
wherein the band-classified noise reduction unit performs the noise reduction process on the lowpass signal of the local region of interest through the ε filter (epsilon filter) application process on each of the plurality of pieces of 1-dimensional data in the Z-axis direction generated from the generated 3-dimensional data.

10. The image processing device according to claim 8,
wherein the band-classified noise reduction unit generates 3-dimensional data in which the lowpass signals of the local region of interest and the similar local regions are set in the XY planes and are superimposed in the Z-axis direction, and
wherein the band-classified noise reduction unit performs the noise reduction process on the lowpass signal of the local region of interest by sequentially performing the following processes of (a) to (c) applying the 3-dimensional data:
(a) a process of generating a plurality of pieces of 1-dimensional wavelet transform data through a 1-dimensional wavelet transform process on each of the plurality of pieces of 1-dimensional data in the Z-axis direction generated from the 3-dimensional data,
(b) a shrinkage process on each of the plurality of pieces of 1-dimensional wavelet transform data, and
(c) a 1-dimensional wavelet inverse-transform process on each of the plurality of pieces of 1-dimensional wavelet transform data after the shrinkage process.

11. The image processing device according to claim 1,
wherein the band separation unit sets an average value in color units of the local regions in each of the local region of interest and the similar local regions as the lowpass signal corresponding to each color in each local region, and
wherein the band separation unit calculates the highpass signal corresponding to each pixel in the local regions in each of the local region of interest and the similar local regions according to the following equation:
highpass signal=(pixel value of each pixel)−(color average value corresponding each pixel).

12. The image processing device according to claim 1,
wherein the image processing unit further includes a reference color calculation unit that generates a reference color image in which a reference color pixel value is set at each pixel position of the RAW image based on the RAW image,
wherein the similar local region selection unit determines similarity to the local region of interest applying the reference color image and selects similar local regions with high similarity to the local region of interest.

13. The image processing device according to claim 12, wherein the reference color pixel value is a luminance value.

14. The image processing device according to claim 1, wherein the RAW image is a RAW image with a Bayer array.

15. The image processing device according to claim 1,
wherein the RAW image is a RAW image with a Bayer array,
wherein the band-classified noise reduction unit generates 3-dimensional data in which band-classified signals of the local region of interest and the similar local regions are set in XY planes and are superimposed in a Z-axis direction, and
wherein the band-classified noise reduction unit generates separation data of a luminance signal and another signal by performing a 2-dimensional wavelet transform process on the band-classified signal of each local region which is XY plane data and performs the noise reduction process applying each piece of the generated separation data.

16. The image processing device according to claim 1,
wherein the local region selection unit sequentially selects the local regions of interest as regions including an overlapping pixel region, and
wherein, when the local region combining unit sequentially inputs the noise-reduced local region-of-interest images including the overlapping pixel region and generates the noise-reduced RAW image through an input image combining process, the local region combining unit performs a process of averaging pixel values of the overlapping pixel region included in the plurality of noise-reduced local region-of-interest images and sets a pixel value of the noise-reduced RAW image.

17. An image processing method performed by an image processing unit of an image processing device, the image processing device including the image processing unit that sets a RAW image in which a pixel value of a specific color is set in each pixel as an input image and reduces a noise component contained in the input image, the method comprising:
selecting a local region of interest as a processing target region from the input image;
selecting similar local regions which have the same phase as the local region of interest and have high similarity to the local region of interest;
separating the local regions in each of the local region of interest and the similar local regions into band-classified signals including a highpass signal and a lowpass signal;
performing a process of reducing noise contained in the band-classified signals generated in the band separation process;
combining band-classified signals after the noise reduction generated in the band-classified noise reduction process to generate noise-reduced local region-of-interest images; and
sequentially inputting the noise-reduced local region-of-interest images generated in the band combining process and generating a noise-reduced RAW image through an input image combining process.

18. A program causing an image processing device to perform image processing, the image processing device including an image processing unit that sets a RAW image in which a pixel value of a specific color is set in each pixel as an input image and reduces a noise component contained in the input image, the program causing the image processing unit to perform:
selecting a local region of interest as a processing target region from the input image,
selecting similar local regions which have the same phase as the local region of interest and have high similarity to the local region of interest;
separating local regions in each of the local region of interest and the similar local regions into band-classified signals including a highpass signal and a lowpass signal;
performing a process of reducing noise contained in the band-classified signals generated in the band separation process;
combining band-classified signals after the noise reduction generated in the band-classified noise reduction process to generate noise-reduced local region-of-interest images; and
sequentially inputting the noise-reduced local region-of-interest images generated in the band combining process and generating a noise-reduced RAW image through the input image combining process.
